(19) United States
(12) Patent Application Publication
(10) Pub. No.: US 2023/0096832 A1
(43) Pub. Date: Mar. 30, 2023

(54) FIRST NODE, SECOND NODE, THIRD NODE, FOURTH NODE, FIFTH NODE AND METHODS PERFORMED THEREBY FOR HANDLING FIRMWARE

(71) Applicant: Telefonaktiebolaget LM Ericsson (publ), Stockholm (SE)

(72) Inventors: Swarup Kumar Mohalik, Bangalore (IN); Ganapathy Raman MADANAGOPAL, Bengaluru (IN); Ramamurthy Badrinath, Bangalore (IN); Anshu Shukla, Bangalore (IN)

(21) Appl. No.: 17/767,951

(22) PCT Filed: Oct. 11, 2019
(86) PCT No.: PCT/IN2019/050757

§ 371 Date: Apr. 11, 2022

(51) Int. Cl. G06F 8/65; G06F 8/61

(52) U.S. Cl. CPC G06F 8/65; G06F 8/61

(57) ABSTRACT

A method, performed by a first node, for handling firmware. The first node receives a first indication from a second node. The first indication indicates a task to be performed by a user equipment. The task indicates an action. The action corresponds to a module of a plurality of modules of firmware to perform the action. The entire plurality of modules of firmware is not installed in the user equipment. The first node downloads the module of firmware corresponding to the action onto the user equipment, based on whether or not the module is already downloaded. The first node then enables, in the user equipment, the downloaded module. The enabling is further based on whether or not the downloaded module of firmware corresponding to the action is already enabled in the user equipment.

### TECHNICAL FIELD

The present disclosure relates generally to a first node and methods performed thereby for handling firmware. The present disclosure further relates generally to a third node and methods performed thereby for handling firmware. The present disclosure further relates generally to a fourth node and methods performed thereby for handling firmware. The present disclosure further relates generally to a fifth node and methods performed thereby for handling firmware.

### BACKGROUND

Communication devices within a telecommunications network may be user equipments (UEs), e.g., stations (STAs), wireless devices, mobile terminals, wireless terminals, terminals, and/or Mobile Stations (MS). User equipments are enabled to communicate wirelessly in a cellular communications network or wireless communication network, sometimes also referred to as a cellular radio system, cellular system, or cellular network. The communication may be performed e.g., between two user equipments, between a user equipment and a regular telephone, and/or between a user equipment and a server via a Radio Access Network (RAN), and possibly one or more core networks, comprised within the telecommunications network. User equipments may further be referred to as mobile telephones, cellular telephones, laptops, or tablets with wireless capability, just to mention some further examples. The user equipments in the present context may be, for example, portable, pocket-storable, hand-held, computer-comprised, or vehicle-mounted mobile devices, enabled to communicate voice and/or data, via the RAN, with another entity, such as another terminal or a server.

The telecommunications network may cover a geographical area which may be divided into cell areas, each cell area being served by a network node, e.g., a radio network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or BTS (Base Transceiver Station), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as user equipments, with serving beams.

The standardization organization 3GPP is currently in the process of specifying a New Radio Interface called NR or 5G-UTRA, as well as a Fifth Generation (5G) Packet Core Network, which may be referred to as Next Generation (NG) Core Network, abbreviated as NG-CN, NGC or 5G CN.

### Internet of Things (IoT)

The Internet of Things (IoT) may be understood as an internetworking of communication devices, e.g., physical devices, vehicles, which may also referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as for the control and automation of lighting via e.g., cameras, light monitors, heating, e.g. a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices are expected to be stationary, e.g., gas and electricity meters, vending machines, etc.

In any IoT device, firmware may be understood to expose a set of capabilities through Application Program Interfaces (APIs). A capability or action, as used herein, may be understood as an operation or function that a device may perform. Firmware may be understood to be software that may control hardware devices, including, albeit exclusively, IoT devices. Firmware may be programmed to give permanent instructions to communicate with other devices and perform functions such as basic input and/or output tasks. Firmware may be understood to provide abstractions over the hardware to higher level applications so that higher level applications may not need to always have to handle low level details in order to interact with the hardware. In the early days, firmwares were etched into hardware and were not changeable. However, currently, firmwares may be updated during the life of the device. During the traditional device life cycle, that is as long as a device may continue to function, the firmware in a device may be upgraded to either fix existing bugs in the capabilities or to add new capabilities. Enhanced capabilities are also considered as new capabilities. Therefore, there may be understood to be a monotonic growth in the device capabilities, which are documented in the release notes.

However, the monotonic growth property is not strictly true for all devices, such as for example, in the case of resource-constrained IoT devices. A constrained device or constrained node may be understood as a node with limited hardware features such as size, weight, and available computing power, memory and energy. This may be the case of Machine Type Communication devices, which due to their high numbers, may have been designed for low cost production and may therefore have, e.g., memory constraints, and processing constraints.

While low cost production has been achieved in these devices, this comes at a performance cost, due to the inability of such devices to perform certain tasks that may be desired by a user, but that may not be supported.

### SUMMARY

It is an object of embodiments herein to improve the handling of firmware in a communications network.

According to a first aspect of embodiments herein, the object is achieved by a method, performed by a first node. The method is for handling firmware. The first node operates in the communications network. The first node receives a first indication from a second node operating in the communications network. The first indication indicates a task to be performed by a user equipment operating in the communications network. The task indicates an action to be performed by the user equipment. The action corresponds to a module of a plurality of modules of firmware to perform the action. The entire plurality of modules of firmware is not installed in the user equipment. The first node also downloads the module of firmware corresponding to the action onto the user equipment. The downloading is performed based on whether or not the module of firmware corresponding to the action onto the user equipment is already downloaded in the user equipment. The first node enables, in the user equipment 130, the downloaded module of firmware corresponding to the action. The enabling is further based on whether or not the downloaded module of firmware corresponding to the action is already enabled in the user equipment.

According to a second aspect of embodiments herein, the object is achieved by a method, performed by a third node. The method is for handling firmware. The third node operates in the communications network. The third node collects information. The information indicates, for a respective module of a plurality of modules of firmware one or more actions. Each of the actions corresponds to a task of a plurality of tasks to be performed by user equipments. Each of the one or more actions comprises a respective set of preconditions and effects. The information also indicates management actions supported by a plurality of types of user equipments. The information further indicates a respective type of user equipments supporting the respective module. The third node generates a first file based on the collected information. The first file has a Planning Domain Definition Language format.

According to a third aspect of embodiments herein, the object is achieved by a method, performed by a fourth node. The method is for handling firmware. The fourth node operates in the communications network. The fourth node monitors whether or not at least one trigger of a plurality of triggers is met in the communications network. Each trigger in the plurality of triggers corresponds to a respective task of a first plurality of tasks to be performed by the user equipment operating in the communications network. The fourth node also outputs a respective goal or goals of a plurality of goals, corresponding to the triggers that are met. The fourth node further generates a second file based on a result of the monitoring and the outputting. The second file has the Planning Domain Definition Language format.

According to a fourth aspect of embodiments herein, the object is achieved by a method, performed by a fifth node. The method is for handling firmware. The fifth node operates in the communications network. The fifth node receives the second indication from the third node operating in the communications network. The second indication comprises the information indicating, for the respective module of the plurality of modules of firmware the one or more actions. Each of the actions corresponds to the task of the plurality of tasks to be performed by user equipments. Each of the one or more actions comprises the respective set of preconditions and effects. The information also indicates the management actions supported by the plurality of types of user equipments. The information further indicates the respective type of user equipment supporting the respective module. The fifth node also receives the third indication from the fourth node operating in the communications network. The third indication indicates the one or more goals of the plurality of goals to be accomplished when at least one trigger of the plurality of triggers is met in the communications network. Each trigger in the plurality of triggers corresponds to the respective task of the first plurality of tasks to be performed by the user equipment operating in the communications network. The third indication also indicates a state of the user equipment. The fifth node further determines, based on the received second indication and the received third indication, a plan to achieve the goal for the respective task to be performed by the user equipment. The determining is based on the respective type of the user equipment.

According to a fifth aspect of embodiments herein, the object is achieved by the first node, for handling firmware. The first node is configured to operate in the communications network. The first node is further configured to receive the first indication from the second node configured to operate in the communications network. The first indication is configured to indicate the task to be performed by the user equipment. The user equipment is configured to operate in the communications network. The task is configured to indicate the action to be performed by the user equipment. The action is configured to correspond to the module of the plurality of modules of firmware to perform the action. The entire plurality of modules of firmware is not installed in the user equipment. The first node is also configured to download the module of firmware corresponding to the action onto the user equipment. The downloading is configured to be performed, based on whether or not the module of firmware corresponding to the action onto the user equipment is already downloaded in the user equipment. The first node is additionally configured to enable, in the user equipment, the module of firmware corresponding to the action configured to be downloaded. To enable is further configured to be based on whether or not the module of firmware corresponding to the action configured to be downloaded is already enabled in the user equipment.

According to a sixth aspect of embodiments herein, the object is achieved by the third node, for handling firmware. The third node is configured to operate in the communications network. The third node is further configured to collect the information. The information is configured to indicate, for a respective module of the plurality of modules of firmware the one or more actions. Each of the actions corresponds to a task of the plurality of tasks to be performed by user equipments. Each of the one or more actions are configured to comprise the respective set of preconditions and effects. The information is also configured to indicate the management actions configured to be supported by the plurality of types of user equipments. The information is further configured to indicate the respective type of user equipments configured to support the respective module. The third node is further configured to generate the first file based on the information configured to be collected. The first file is configured to have the Planning Domain Definition Language format.

According to a seventh aspect of embodiments herein, the object is achieved by the fourth node, for handling firmware. The fourth node is configured to operate in the communications network. The fourth node is further configured to monitor whether or not at least one trigger of the plurality of triggers is met in the communications network. Each trigger in the plurality of triggers corresponds to a respective task of the first plurality of tasks to be performed by a user equipment. The user equipment operates in the communications network. The fourth node is further configured to output the respective goal or goals of the plurality of goals, corresponding to the triggers that are configured to be met. The fourth node is also configured to generate the second file based on the result of the monitoring and the outputting. The second file is configured to have the Planning Domain Definition Language format.

According to an eighth aspect of embodiments herein, the object is achieved by the fifth node, for handling firmware. The fifth node is configured to operate in the communications network. The fifth node is further configured to receive the second indication from the third node. The third node is configured to operate in the communications network. The second indication is configured to comprise the information indicating, for a respective module of the plurality of modules of firmware, the one or more actions. Each of the actions corresponds to a task of the plurality of tasks to be performed by user equipments. Each of the one or more actions comprise a respective set of preconditions and effects. The information is further configured to indicate, for a respective module of the plurality of modules of firmware, the management actions supported by the plurality of types of user equipments. The information is also configured to indicate, for a respective module of the plurality of modules of firmware, the respective type of user equipment supporting the respective module. The fifth node is also configured to receive the third indication from the fourth node. The fourth node is configured to operate in the communications network. The third indication is configured to indicate the one or more goals of the plurality of goals to be accomplished when at least one trigger of the plurality of triggers is met in the communications network. Each trigger in the plurality of triggers corresponds to a respective task of the first plurality of tasks to be performed by the user equipment. The user equipment is configured to operate in the communications network. The third indication is also configured to indicate the state of the user equipment. The fifth node is additionally configured to determine, based on the second indication configured to be received and the third indication configured to be received, the plan. The plan is to achieve the goal for the respective task to be performed by the user equipment. The determining is configured to be based on the respective type of the user equipment.

By the first node downloading the module of firmware corresponding to the action to be performed by the user equipment, based on whether or not the module is already downloaded in the user equipment, and enabling it based on whether or not it is already enabled, the first node is enabled to orchestrate the different firmware modules to provide the right capabilities that may be needed to execute the tasks to be performed by the user equipment. This may be understood to enable the user equipment to perform tasks that may require capabilities from both new and old firmwares, which in e.g., constraint devices, may not be possible to install simultaneously in the user equipment. The first node may, by virtue of the embodiments herein, be enabled to swap new and old modules to execute the different tasks, as needed. This may be understood to enhance the performance of the user equipment, and provide a way to overcome memory and/or processing power limitations.

By the third node collecting the information and generating the first file, and by the fourth node monitoring the triggers and generating the second file, the fifth node may be enabled to receive the second and third indications, respectively, and determine the plan to achieve the goal for the respective task to be performed by the user equipment, which may then be executed by the first node using the dynamic orchestration of firmware.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications network, according to embodiments herein.

FIG. 2 is a schematic diagram illustrating a non-limiting example of how some terms described in embodiments herein relate to each other.

FIG. 3 is a flowchart depicting embodiments of a method in a first node, according to embodiments herein.

FIG. 4 is a flowchart depicting embodiments of a method in a third node, according to embodiments herein.

FIG. 5 is a flowchart depicting embodiments of a method in a fourth node, according to embodiments herein.

FIG. 6 is a flowchart depicting embodiments of a method in a fifth node, according to embodiments herein.

FIG. 7 is a schematic diagram depicting a non-limiting example of a first file, according to embodiments herein.

FIG. 8 is a schematic diagram depicting a non-limiting example of a second file, according to embodiments herein.

FIG. 9 is a schematic diagram depicting a non-limiting example of a third file, according to embodiments herein.

FIG. 10 is a schematic diagram illustrating a non-limiting example of a communications network, according to examples of embodiments herein.

FIG. 11 is a schematic diagram depicting a non-limiting example of signalling between nodes in a communications network, according to embodiments herein.

FIG. 12 is a schematic diagram depicting another non-limiting example of signalling between nodes in a communications network, according to embodiments herein.

FIG. 13 is a schematic block diagram illustrating two non-limiting examples, a) and b), of a first node, according to embodiments herein.

FIG. 14 is a schematic block diagram illustrating two non-limiting examples, a) and b), of a third node, according to embodiments herein.

FIG. 15 is a schematic block diagram illustrating two non-limiting examples, a) and b), of a fourth node, according to embodiments herein.

FIG. 16 is a schematic block diagram illustrating two non-limiting examples, a) and b), of a fifth node, according to embodiments herein.

### DETAILED DESCRIPTION

As part of the development of embodiments herein, a problem with exiting methods will first further discussed.

As discussed earlier, it may be the case that as firmware is developed, certain capabilities that were available in earlier firmwares are no longer supported by new firmware. In some devices, such as constrained devices, due to memory constraints, decisions are made to drop earlier, that is, legacy features, often those that may be used infrequently and which may not no longer be supported by changed hardware, to make space for the newer features, that is, capabilities. Therefore, new firmware may not support certain capabilities that were available in earlier firmwares.

This problem may be considered to be similar to web service composition, where several microservices may be selected and composed to achieve the requirements of a certain task. The microservices may be considered to be analogous to the capabilities mentioned above. However, constraint devices, such as those that may be found in an IoT scenario, may be understood to impose the following additional requisites. The first requisite may be understood to be locality, as the capabilities may be understood to be required to be available in the device. The second requisite may be understood to be that not all capabilities may be part of the firmware at the same time, as this may lead to bloating of the firmware size, and the device may not have enough memory to store it, and/or processing power to execute it. These restrictions may be understood to not apply to the case of micro-services that are hosted in large data centers and/or the cloud, as hardware limitations do not apply to them.

In existing methods, planning and execution of tasks may only be performed with the version of firmware on board in a device. Therefore, only those capabilities supported by the installed version of the firmware may be available in the device to perform a task. In addition, if a particular task needs to be executed by a device which requires capabilities from earlier versions of the firmware that are not installed in the device, as well as capabilities supported by the installed version, existing methods do not provide any support to leverage capabilities from different firmwares in order to enable the execution of such a task.

Certain aspects of the present disclosure and their embodiments may provide solutions to these or other challenges. Embodiments herein address the restrictions of the existing methods explained above to support legacy tasks in devices that, e.g., may be constrained. Scenarios may be envisaged, where different tasks may require capabilities from both new and old firmwares, with the hardware remaining the same. In such a case, embodiments herein relate to the design of a controller that may swap new and old firmware to execute the different tasks. This may be accomplished efficiently by dividing the firmware into smaller firmwares, which are called herein modules, wherein each module may provide a subset of capabilities or actions. This may then enable to obviate the need for swapping the entire firmware. The capabilities or actions in a device may therefore be grouped into modules. Embodiments herein may be understood to provide a system that, input with a sequence of tasks, may orchestrate the different firmware modules to provide the right capabilities that may be needed to execute the tasks. It may be noted that, by module, it is meant herein packages of the firmware with different sets of capabilities, and not necessarily incremental changes.

In summary, embodiments herein may be understood to be drawn to a customization of firmware installed in a device performed on the fly, in order to support the execution of various tasks in a user equipment that may comprise one or a plurality of devices. A task may be understood herein as a specific state to be achieved by the one or the plurality of devices in the user equipment. Tasks may be specified through <trigger, goal> pairs. For each task, the service of embodiments herein may invoke an Artificial Intelligence (AI) planner to synthesize a sequence, or a partial order, of capability invocations in order to support execution of the task, possibly mixed with management actions to select the right modules to change a firmware composition of a user equipment.

The embodiments will now be described more fully hereinafter with reference to the accompanying drawings, in which examples are shown. In this section, embodiments herein are illustrated by exemplary embodiments. It should be noted that these embodiments are not mutually exclusive. All possible combinations are not described to simplify the description. Components from one embodiment or example may be tacitly assumed to be present in another embodiment or example and it will be obvious to a person skilled in the art how those components may be used in the other exemplary embodiments.

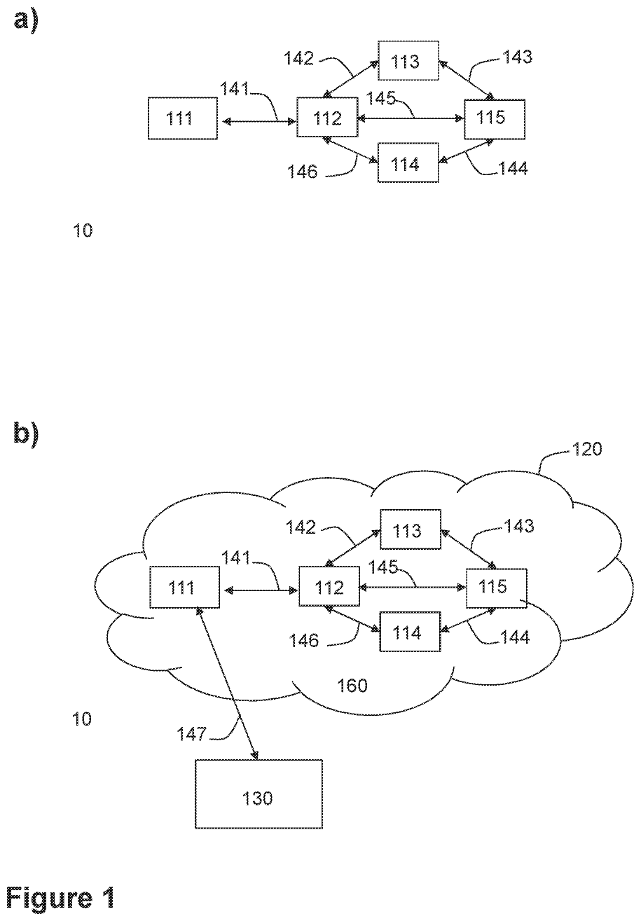

FIG. 1 depicts two non-limiting examples, in panels “a” and “b”, respectively, of a communications network 10, in which embodiments herein may be implemented. In some example implementations, such as that depicted in the non-limiting example of FIG. 1a, the communications network 10 may be a computer network. In other example implementations, such as that depicted in the non-limiting example of FIG. 1b, the communications network 10 may be implemented in a telecommunications network 100, sometimes also referred to as a cellular radio system, cellular network or wireless communications system. In some examples, the telecommunications network 100 may comprise network nodes which may serve receiving nodes, such as wireless devices, with serving beams.

In some examples, the telecommunications network 100 may for example be a network such as 5G system, or Next Gen network, or a newer system supporting similar functionality. The telecommunications network 100 may also support other technologies, such as for example be a Low Power Wide Area Network (LPWAN). LPWAN technologies may comprise Long Range physical layer protocol (LoRa), Haystack, SigFox, LTE-M, and Narrow-Band IoT (NB-IoT). Other technologies that may be supported by the telecommunications network 100 may be for example a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

Although terminology from Long Term Evolution (LTE)/5G has been used in this disclosure to exemplify the embodiments herein, this should not be seen as limiting the scope of the embodiments herein to only the aforementioned system. Other wireless systems, support similar or equivalent functionality may also benefit from exploiting the ideas covered within this disclosure. In future radio access, e.g., in the sixth generation (6G), the terms used herein may need to be reinterpreted in view of possible terminology changes in future radio access technologies.

The communications network 10 may comprise a plurality of nodes, whereof a first node 111, a second node 112, a third node 113, a fourth node 114 and a fifth node 115 are depicted in FIG. 1. Any of the first node 111, the second node 112, the third node 113, the fourth node 114 and the fifth node 115 may be understood, respectively, as a first computer system, a second computer system, a third computer system, a fourth computer system, and a fifth computer system. In some examples, any of the first node 111, the second node 112, the third node 113, the fourth node 114 and the fifth node 115 may be implemented as a standalone server in e.g., a host computer in the cloud 120. Any of the first node 111, the second node 112, the third node 113, the fourth node 114 and the fifth node 115 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the third node 113, the fourth node 114 and the fifth node 115 may also be implemented as processing resources in a server farm. Any of the first node 111, the second node 112, the third node 113, the fourth node 114 and the fifth node 115 may be under the ownership or control of a service provider, or may be operated by the service provider or on behalf of the service provider.

In some embodiments, any of the first node 111, the second node 112, the third node 113, the fourth node 114 and the fifth node 115 may be independent and separated nodes. In other embodiments, any of the first node 111, the second node 112, the third node 113, the fourth node 114 and the fifth node 115 may be co-located, or be the same node. All the possible combinations are not depicted in FIG. 1 to simplify the Figure.

In some examples of embodiments herein, the first node 111 may be understood as an executor, or a node capable of performing a similar function in the communications network 10, according to the actions described in reference to FIG. 3.

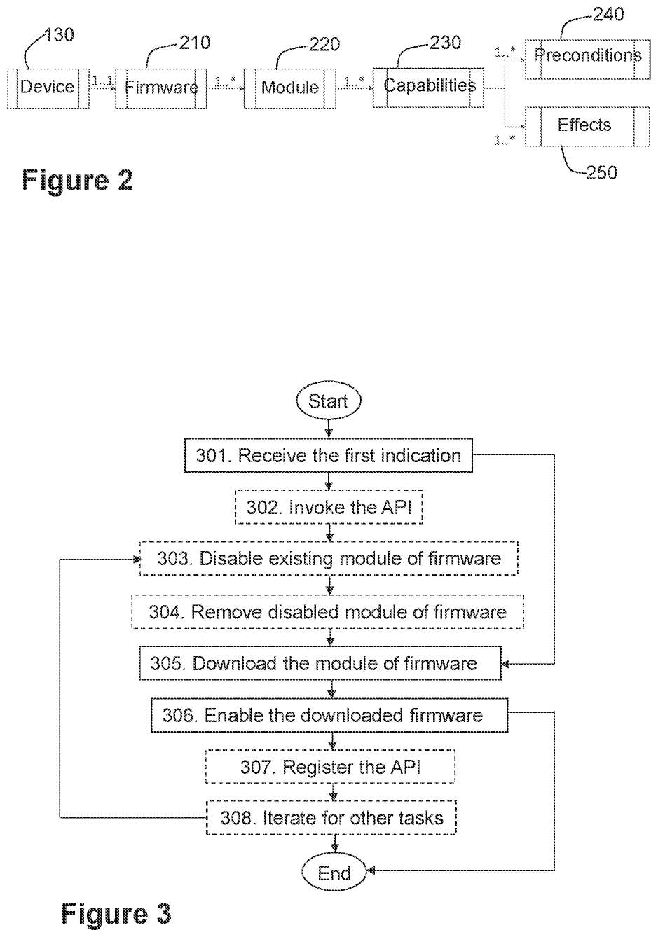

The second node 112 may be understood, based on context, as one of a Knowledge base or an AI planner, or a node capable of performing similar functions in the communications network 10, as will be described later. The knowledge base may be understood to comprise specific knowledge items with respect to a device, such as the user equipment 130, which is described later. The specific knowledge items, as schematically represented in FIG. 2, may include: 1) mapping of devices to name of modules of firmware 210, an identifier (ID), and a REST endpoint that may be a base URL for access to the firmware 210, 2) modules 220 of firmware 210 and extensions to the base URL to access a specific module 220, 3) mapping of capabilities 230, or actions, to each module 220, and 4) for each action 230, one or more preconditions 240, which may be understood as a set of predicates, and effects 250, that may be understood as a set of predicates to be added and set of predicates to be deleted.

The AI Planner, as used herein, may be understood as a node capable of, given a problem, generate a plan using artificial intelligence methods. This plan may be understood to provide a sequence of actions that takes a user equipment, such as the user equipment 130 described below, from a current state to a state satisfying the goal of the task. Thus, the plan may be seen as an implementation of a task specification. In examples herein, the AI planner may be an off-the-shelf planner, such as e.g., Metric-FF, that may take a Planning Domain Definition Language (PDDL) domain, a PDDL problem and may then generate a plan.

The third node 113 may be a Domain Builder, or a node capable of performing a similar function in the communications network 10. The domain builder may be understood to collect all the actions or capabilities, along with their preconditions and effects, and also the management actions, such as download, enable, disable and remove, and build a PDDL domain file. The precondition for a capability C may include the predicate enabled-capability(C). A capability may be understood to need to be enabled, in order for it to be allowed in a construction of a plan.

The fourth node 114 may be understood as a node capable of detecting a problem in the user equipment 130 described below, by monitoring information collected by the user equipment 130, e.g., current sensor values, e.g., doorOpen, sensor_OK etc. . . . . The information may be triggers associated with the set of tasks provided by a user. When there are matching triggers, it may collect the goal predicates and generate a problem file. The fourth node 114 may be understood as a Problem Builder or a node capable of performing a similar function in the communications network 10.

The fifth node 115 may be an AI Planner, as described above, or a node capable of performing a similar function in the communications network 10.

Any of the first node 111, the second node 112, the third node 113, the fourth node 114 and the fifth node 115 may be a core network node implemented within, e.g., a Network Data Analytics Function (NWDAF), Service GW node (SGW), Packet data GW node (PGW), Self-Organizing Network (SON) node, Operation Support System node (OSS), or similar coordinating and assistance node for supervising and assistance in network management and operation.

The communications network 10 may comprise one or more radio network nodes, which are not depicted in FIG. 1 to simplify the figure. Each of the one or more radio network nodes may typically be a base station or Transmission Point (TP), or any other network unit capable to serve a wireless device or a machine type node in the communications network 10. Any of the one or more radio network nodes may be e.g., a 5G gNB, a 4G eNB, or a radio network node in an alternative 5G radio access technology, e.g., fixed or WiFi. Any of the one or more radio network nodes may be e.g., a Wide Area Base Station, Medium Range Base Station, Local Area Base Station and Home Base Station, based on transmission power and thereby also coverage size. Any of the one or more radio network nodes may be a stationary relay node or a mobile relay node. Any of the one or more radio network nodes may support one or several communication technologies, and its name may depend on the technology and terminology used. Any of the one or more radio network nodes may be directly connected to one or more networks and/or one or more core networks.

The communications network 10 covers a geographical area which may be divided into cell areas, wherein each cell area may be served by a radio network node, although, one radio network node may serve one or several cells.

The communications network 10 may comprise on or more user equipments, of which a user equipment 130 is depicted in FIG. 1b. The user equipment 130 may be also known as e.g., a wireless device, mobile terminal, wireless terminal and/or mobile station, mobile telephone, cellular telephone, or laptop with wireless capability, or a Customer Premises Equipment (CPE), just to mention some further examples. The user equipment 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications network 10. The user equipment 130 may be wireless, i.e., it may be enabled to communicate wirelessly in the communications network 10 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications network 10. In some particular embodiments, the user equipment 130 may be an IoT device, e.g., a NB IoT device. In further particular embodiments, the user equipment 130 may be a non-critical massive IoT device. Massive non-critical IoT devices may be understood as devices, e.g., sensors, weather parameter devices to read humidity, sunshine, etc., whose communication may be delayed without really affecting the end users. Also, in some examples described herein, the user equipment 130 may manage, control and/or comprise one or more devices, such as IoT devices. In such examples, the user equipment 130 may be understood as an IoT system. An IoT system may be, for example, an intruder detection system comprising a camera, and light intensity measuring device.

The first node 111 may communicate with the second node 112 over a first link 141, e.g., a radio link or a wired link. The second node 112 may communicate with the third node 113 over a second link 142, e.g., a radio link or a wired link. The third node 113 may communicate with the fifth node 115 over a third link 143, e.g., a radio link or a wired link. The fourth node 114 may communicate with the fifth node 115 over a fourth link 144, e.g., a radio link or a wired link. The fifth node 115 may communicate with the second node 112 over a fifth link 145, e.g., a radio link or a wired link. The second node 112 may communicate with the fourth node 114 over a sixth link 146, e.g., a radio link or a wired link. The first node 111 may communicate with the user equipment over a seventh link 147, e.g., a radio link or a wired link.

Any of the first link 141, the second link 142, the third link 143, the fourth link 144, the fifth link 145, the sixth link 146, and/or the seventh link 147 may be a direct link or it may go via one or more computer systems or one or more core networks in the communications network 10, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 1.

In general, the usage of “first”, “second”, “third”, “fourth”, “fifth”, “sixth”, and/or “seventh” herein may be understood to be an arbitrary way to denote different elements or entities, and may be understood to not confer a cumulative or chronological character to the nouns they modify.

FIG. 2 is a schematic diagram illustrating the relationship between the different terms used herein. Each device, e.g., the user equipment 130, may be understood to comprise firmware. In examples wherein the user equipment 130 may be e.g., an IoT system comprising a plurality of devices, each of the devices may be understood to comprise respective firmware. For example, a camera may comprise firmware, a light intensity device may comprise firmware, etc. The firmware in each device may comprise one or more modules. A module may be understood as an independent firmware unit that may allow to be composed with other modules to build the firmware for the device. For example, possible modules of a camera may from the set {camera_module1, camera_module2, Process_module1}. Possible modules of a light intensity device (LI) may be from the set {Act_MeasureLI}. Each module may support a, possibly different, number of capabilities, also referred to herein as actions. A capability may understood to provide a functionality through corresponding APIs provided in the module. Embodiments herein may address the scenario of the user equipment 130 as an IoT user equipment with multiple modules of firmware, wherein each module may control performance of different capabilities for each of the parts, elements or devices, such as e.g., a camera, or a light intensity monitor, that may be comprised in or managed by the user equipment 130, or by the user equipment 130 itself, in the examples where the user equipment 130 may be only one device. There may be multiple modules of firmware for each device, each bundling a different set of capabilities, where capabilities may be considered analogous to microservices.

A capability may be: 1) referred to via a name, 2) specified through <precondition, effect> pairs for its functionality, and 3) executed through an API in the module. For example, for a first LI module, which may be expressed as “LI_Module_1”, a capability may be to measure the light intensity, which may be expressed as “Act_measureLI”, for another module expressed as “Image_Module_1” a capability may be to take a high resolution image, expressed as “Act_TakeHighResImage”, for yet another module expressed as “Image_Module_2”, a capability may be to take a low resolution image expressed as “Act_TakeLowResImage”, or to enhance an image expressed as “Act_EnhanceImage”. For yet another module expressed as “Process_Module_1”, a capability may be to process an image, expressed as “Act_ProcessImage”.

Precondition and effects may be understood as boolean combination of predicates. The predicates may be understood to capture aspects of a state of the user equipment 130 and environment and may take only boolean values. During execution of methods herein, these predicates may be evaluated to be either True or False, either from sensor data or by the APIs asserting them in the knowledge base. For example, given the precondition that the light intensity is OK and a door is open, expressed as “(LI_OK and OpenDoor)”, for the capability to take a high resolution image, expressed as “Act_TakeHighResImage”, the effect is that a good image has been obtained by executing the capability, expressed as “(Is_GoodImage)”.

The capabilities comprised in a module may be designed taking into account both technical characteristics, such as the degree of interactions among the capabilities, and non-technical characteristics, such as the development teams. Such a user equipment 130 may be assigned tasks that may involve capabilities across devices. The firmware of the user equipment 130, that is, the firmware modules that may be selected according to embodiments herein, may be re-composed dynamically depending upon the task(s) to be executed. In the simplest scenarios, a single user equipment 130 may comprise a single module. There may be different modules of the firmware and at any point of time, and, due to constraints of the user equipment 130, there may be only some, not necessarily all, of the modules deployed in the user equipment 130. Particular embodiments herein may be understood to relate to a system and method for firmware orchestration in constrained IoT devices. As schematically depicted in FIG. 2, each device in a user equipment such as the user equipment 130 may have, for a respective first module of firmware “1”, and a first module “1” of the first module, a first capability, or action, “1” of the first module, which may in turn have a first precondition “1” of the first capability, and a first effect “1” of the first capability “1”. The mapping of this information, as schematically illustrated in FIG. 2, for a single capability, module, firmware, and device, may be stored in the second node 112. More particularly, embodiments herein may be provided through a service provided in IoT middleware. The service may maintain the following in a knowledge base: 1) a mapping between <device, firmware, module> to one or more capabilities of a device; 2) a base Uniform Resource Locator (URL), where each module of a module may expose: (i) the capabilities and a namespace for the capabilities, that is, the names by which these capabilities may be referred to, and (ii) semantics of all the capabilities through preconditions and effects; and 3) a set of management actions—download, enable, disable and remove—along with their semantics.

Example Scenario: To help to describe the actions of the methods disclosed herein, an example scenario will be used in a non-limiting fashion, and for illustrative purposes only, wherein the user equipment 130 is an IoT-based system comprising a three IoT devices: a light intensity monitor, a camera, and a thermal imaging camera and light intensity sensor. The user equipment 130 has, in this non-limiting example, the following modules: 1) a light intensity monitor module, 2) a camera module capable of taking high- and low-resolution images, and 3) a thermal imaging camera and light intensity sensor module. The user equipment 130, as used herein, may therefore be comprised of one or more individual components or devices, which may be considered as individual user equipment themselves. However, it may be understood that embodiments herein equally apply to scenarios wherein the user equipment 130 is a single device.

Embodiments of method, performed by the first node 111, will now be described with reference to the flowchart depicted in FIG. 3. The method may be understood to be for handling firmware, e.g., in the user equipment 130. The first node 111 operates in the communications network 10. In examples of embodiments herein, the first node 111 may be referred to as an executor.

The method may comprise the actions described below. In some embodiments some of the actions may be performed. In some embodiments all the actions may be performed. In FIG. 3, an optional action is indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

Action 301

In this Action 301, the first node 111 receives a first indication from the second node 112 operating in the communications network 10. The first indication indicates a task to be performed by the user equipment 130 operating in the communications network 10.

A task may be understood as a job to be performed to achieve a goal, given the presence of a certain circumstance or trigger. A task may therefore be specified as a tuple <trigger, Goal>, where trigger may be understood as a message that may signal the commencement of the task, and a goal may be understood as a set of predicates. In the non-limiting example used for illustrative purposes herein, the task is, e.g., intrusion detection, which may be specified as: OpenDoor→SUCC_IntrusionDetection. In this example, the task means that, whenever the door is open, which is the trigger in the example, the goal of detecting the intruder, represented by the predicate SUCC_IntrusionDetection, should be successfully achieved.

The task indicates an action to be performed by the user equipment 130. The task may be understood to be achieved using one or more capabilities, or actions. Each action, as described earlier, may be understood to describe a functionality. For example, to achieve the goal of detecting an intruder, certain actions may need to be performed. In the example used herein, a first action may be e.g., to take a high resolution image, represented as “Act_takeHighResImage”. Different capabilities or actions may exist for different modules, and therefore, for different devices. For example, this action may be performed by a “Camera” module. A second action may be e.g., to measure light intensity, represented as “Act_measureLI”, which may be performed by a “Monitor” module.

The action corresponds to, that is, is supported by, a module of a plurality of modules of firmware to perform the action. That is, each action may be supported by a module of firmware. Different actions may be supported by different different modules of firmware.

The entire plurality of modules of firmware is not installed in the user equipment 130. This may be understood to be because the user equipment 130 may be a constrained device with, e.g., limited memory to be able to store the entire plurality of modules.

According to the foregoing, in the provided example the modules, and the capabilities or actions may be as follows:

Device: Low Intensity (LI) monitor
Module: LI_Module_1
   Action: Measure Light intensity “Act_measureLI”

### Device: Camera

Module 1: Image_Module_1
   Action: Take a high resolution image “Act_TakeHighResImage”
Module 2: Image_Module_2
   Action 1: Take a low resolution image “Act_TakeLowResImage”
   Action 2: Enhance the image “Act_EnhanceImage”
Module 3: Process_Module_1
   Action 1: Process the image “Act_ProcessImage”

As mentioned earlier, each action or capability may be represented as a pair of <precondition, effect> of sets of predicates. For example, the semantics of the actions capabilities may be specified as follows.

Using the non-limiting example scenario used herein, the semantics of the actions or capabilities may be specified as follows. Whenever the door is open, the OpenDoor message may be received by the first node 111, which may then start an AI planning in the third node 113 to achieve the SUCC_IntrusionDetection predicate:
Precondition 0: (OpenDoor)
   Action 1: Act_measureLI
      (LI>=0)→(LI_OK)
      (LI<=0)→(LI_NOK)
Precondition 1: (LI_OK and OpenDoor)
   Action 1: Act_TakeHighResImage
      Effect 1: (Is_GoodImage)
Precondition 2: (LI_NOK AND OpenDoor)
   Action 2: Act_TakeLowResImage
      Effect 2: (Is_LowResImage)
Precondition 3: (Is_LowResImage)
   Action 3: Act_EnhanceImage
      Effect 3: (Is_GoodImage)
Precondition 4: (Is_GoodImage)
   Action 4: Act_ProcessImage
      Effect 4: (SUCC_IntrusionDetection)

In addition, in some examples, the capabilities or actions may comprise the following management actions with the corresponding preconditions and effects, wherein the meaning of the predicates may be as follows:
(is-in-store f m) may be understood to mean that the module m of firmware f is in the store
Enabled-capability(c) may be understood to mean that the capability c is enabled
Enabled (f, m) may be understood to mean that module m of firmware f is enabled
Capability (c, f, m) may be understood to mean that capability c is in the module m of firmware f
Is-in-device (f, m) may be understood to mean that module m of firmware f is in the device
Action 1: Download (f: firmware, m: module)
   Precondition: (is-in-store f m)
   Effect: (is-in-device f m) AND not (enabled(c, f, m)))
Action 2: Enable (f: firmware, m: module)
   Precondition: (is-in-device f m), not (enabled (f, m))
   Effect: enabled(c,f,m) AND (for-all (c) (capability (c, f, m)=>enabled-capability(c))) AND enabled (f, m)
Action 3: Disable (f: firmware, m: module)
   Precondition: (is-in-device f m), enabled (f, m)
   Effect: not(enabled(c, f, m)) AND (for-all (c) (capability (c, f, m)=>not(enabled-capability(c))))
Action 4: Remove
   Precondition: (is-in-device m), (enabled m)
   Effect: (for-all (c) (capability c, f, m)=>not (enabled-capability (c))
      AND not (enabled (c, f, m) AND not (is-in-device m)

The action predicates may be designed by a domain developer. For example, the action “Act_takeHighResImage”, if enabled, may acquire a good image “Is_GoodImage” when it executes, if the light intensity is OK “LI_OK” and the door is open “OpenDoor”:
(LI_OK and OpenDoor and (capability-enabled Id_Act_takeHighResImage))
   Act_takeHighResImage
(Is_GoodImage)
   In this Action 301, the receiving may be implemented, e.g., via the first link 141.

Action 302

For any device, such as the user equipment 130, e.g., an IoT device, it may be assumed herein that the capabilities and the management actions on a device may be implemented via an interface. In this Action 302, the first node 111 may invoke, on the user equipment 130 and based on the received first indication, an Application Program Interface (API), corresponding to the action.

To invoke the API may be understood as instructing the user equipment 130, or a device of the user equipment 130 to execute the code corresponding to the API. The API may be e.g., a REST API.

As an example a server, e.g., a Lightweight Machine to Machine (LWM2M) server, may provide this interface.

The first node 111 may invoke the API from e.g., a LWM2M server Representational State Transfer (REST) API.

An API may be considered to be registered when a module with the corresponding capability resides in the user equipment 130, or a device of user equipment 130, and is enabled for the first time. If the API is already registered it may be understood to remain registered until the end of life of the user equipment 130, or the device of user equipment 130. However, due to memory constraints, the registration to the APIs corresponding to the capabilities may be restricted in various ways with the constraint that it may always be necessary to register at least the APIs corresponding to the capabilities of enabled modules. Registering may be understood to be performed to map action names in the modules to the actual function names or URLs of APIs that may be invoked for execution

According to the foregoing, the first node 111 may be understood to be able to take a plan and invoke the corresponding REST APIs from an interface, e.g., from a LWM2M server, in the order that may be required.

The invoking in this Action 302 may be further based on whether or not the API corresponding to the action onto the user equipment 130 is already registered. If a module is enabled, it may be understood that the APIs corresponding to its actions may already registered, hence the actions may be invoked.

Action 303

In this Action 303, the first node 111 may disable, in the user equipment 130, and based on the received first indication, any other module in the plurality of modules of firmware lacking support for the action. The purpose of performing this Action 303 may be understood to be to manage the storage and processing resources of the user equipment 130, or any of the devices comprised in it or managed by it, so that unnecessary firmware modules to perform the action are not enabled in the user equipment 130, taking resources of the user equipment 130 unnecessarily, given that it may be a constraint device. The fact that this Action 303 may be based on the received first indication may be understood to mean that only modules of firmware lacking support for the action indicated in the received first indication may be disabled. If the indicated action is supported by the module of firmware already enabled in the user equipment 130 at the moment of performing the task, the first node 111 need not need to perform this disabling action.

This Action 303 may be performed by, for example, having a LWM2M server interact with the user equipment 130 to disable the mentioned module, and register and/or de-register the actions or capabilities of the module with the server. As stated earlier, in embodiments herein, the user equipment 130 may be a single device, or manage or control the performance of one or more devices.

Action 304

In this Action 304, the first node 111 may remove, from the user equipment 130, and based on the received first indication, at least one disabled module in the plurality of modules of firmware lacking support for the action. The removing in this Action 304 may be based on an available storage capacity in the user equipment 130.

Similarly to Action 303, the purpose of performing this Action 304 may be understood to be to manage the storage resources of the user equipment 130, so that unnecessary firmware modules to perform the action are not stored in the user equipment 130, taking resources of the user equipment 130 unnecessarily, given that it may be a constrained device. The fact that this Action 304 may be based on the received first indication may be understood to mean that only disabled modules of firmware lacking support for the action indicated in the received first indication may be removed. If the indicated action is supported by the module of firmware disabled in the user equipment 130, the first node 111 need not need to perform this removing action.

This Action 304 may be performed by, for example, having the LWM2M server remove an inactive firmware module from the memory of the user equipment 130. This along with the requirement of memory for download may capture the memory constraints in the IoT device. In another embodiment, different modules of firmware may be cached when download cost is specified in the semantics of download action and planning may be expected to minimize the download.

Action 305

In this Action 305, the first node 111 downloads the module of firmware corresponding to the action onto the user equipment 130, based on whether or not the module of firmware corresponding to the action onto the user equipment 130 is already downloaded in the user equipment 130. In other words, if the module of firmware corresponding to the action is already downloaded in the user equipment 130, the first node 111 may no longer need to download it. If, however, the module of firmware corresponding to the action is not downloaded in the user equipment 130, the first node 111 may download it.

By performing this conditional downloading, the memory resources of the user equipment 130, which may be limited, may be managed, while still allowing the user equipment 130 to perform any necessary actions, without being limited to the subset of actions that may be supported by a given module of firmware. Any necessary modules of firmware supported a desired action for a task may be downloaded on an on-demand basis, on the fly, by having the first node 111 orchestrate the sequence of downloads that may be required.

This Action 305 may be performed by, for example, having the LWM2M server interact with the URL for the module, to access and download the required module according to the specification.

Action 306

In this Action 306, the first node 111 enables, in the user equipment 130, the downloaded module of firmware corresponding to the action. The enabling in this Action 306 is further based on whether or not the downloaded module of firmware corresponding to the action is already enabled in the user equipment 130.

In other words, if the module of firmware corresponding to the action is already downloaded in the user equipment 130, and already enabled, the first node 111 may no longer need to enable it. If the module of firmware corresponding to the action has been downloaded, e.g., in Action 305, and is not yet enabled, the first node 111 may then enable it in this Action 306.

Action 307

In this Action 307, the first node 111 may register, in the user equipment 130, an API corresponding to the action. The registering in this Action 307 may be based on whether or not the API corresponding to the action onto the user equipment 130 is already registered.

In other words, if the API corresponding to the action is already registered in the user equipment 130, the first node 111 may no longer need to register it. If the API corresponding to the action has not yet been registered, the first node 111 may then register it in this Action 307.

As stated earlier, registering may be understood to be performed to map action names in the modules to the actual function names or URLs of APIs that may be invoked for execution.

When a firmware is enabled on the device, the second node 112 may be used to register the actions or capabilities with e.g., an LWM2M server.

Action 308

At any point of time, the requirement of a user of the communications network 10 may therefore be queued as a set of tasks. It may be understood that a same trigger may be associated with more than one goal, and hence more than one task. The trigger may be generated in the communications network 10, e.g., by a measurement from a sensor in the user equipment 130, or come from external systems to the first node 111, and signal the set of tasks whose goals may need to be satisfied at a particular moment. Once the trigger may arrive, the third node 113 may generate a plan to achieve a group of combined goals of the tasks.

The plan may then be indicated to the first node 111 in the first indication. The generated plan may be either a sequence or a partial order of both module capabilities and management actions to manage the modules downloaded or to be downloaded in the user equipment 130.

According to the foregoing, in some embodiments, the task may be comprised in a first plurality of tasks to be performed by the user equipment 130, as part of a plan indicated by the first indication. In some of such embodiments, the first node 111 may, in this Action 308, iterate one or more of: the invoking of Action 302, the downloading of Action 305, the enabling of Action 306 and the registering of Action 307, for every task comprised in the first plurality of tasks.

The plan may then be executed by the first node 111 till completion.

When a task is to be executed, the corresponding plan may be executed through an execution module which may execute the management actions to change the firmware, and may then execute the APIs for the required capabilities in the sequence, or partial order dictated by the plan. Only after the plan completion, may the first node 111 start listening to one or more further triggers for further tasks.

It may be understood that a same task may, at different times, require different modules that may have to be downloaded onto the device and enabled, while others may need to be enabled. Hence, it may be understood that the order and combination of the actions depicted in FIG. 3 is a non-limiting example. The order and combination may be changed in every iteration.

Continuing with the illustrative scenario described herein, the following are two different non-limiting example scenarios where the first node 111 may perform a method according to embodiments herein.

First example: In this first example it will be illustrated how different modules may need to be downloaded of for a same task. The task in this example is: (OpenDoor 4 SUCC_IntrusionDetection). This may be understood to mean that when OpenDoor predicate is true, indicating the door is opened, the modules in the firmwares in the devices may need to orchestrate to achieve the predicate SUCC_IntrusionDetection. It will be illustrated that the modules to be downloaded may depend upon different situations at different points in time.

When the light intensity is good, the plan generated that may be received by the first node 111 in Action 301 may be:

Download LI_Module_1
Enable LI_Module_1
Download Camera_Module_1
Download Process_Module_1
Enable Camera_Module_1
Enable Process_Module1
Act_measureLI
Act_takeHighResImage
Act_ProcessImage

According to the plan, the modules required for the different components of the user equipment 130 in this non-limiting example are:
LI Monitor: LI_module_1
Camera: Image_Module_1, Process_Module_1

These modules may be downloaded, according to Action 305, from a repository if they are not already downloaded in the user equipment 130.

They may be then enabled, according to Action 306, to provide the capabilities or actions. Then the plan may be executed to achieve the predicate—which may in turn result in intrusion detection.

At a later point, when the light intensity is bad, the plan generated that may be received by the first node 111 in Action 301 may be:

Remove Camera_Module_1
Download Camera_Module_2
Enable Camera_Module_2
Act_MeasureLI
Act_TakeLowResImage
Act_EnhanceImage
Act_ProcessImage

And hence the modules required on the user equipment 130 are:
LI Monitor: LI_module_1
Camera: Image_Module_2, Process_Module_1

Therefore, if Image_Module_2 is to be downloaded, according to Action 305, assuming the Image_Module_1 and _2 may not reside simultaneously in the user equipment 130 due to memory constraints. In this case, Image_Module_1 may need to be removed from the user equipment 130, and then Image_Module_2 may need to be downloaded and enabled on the camera device, according to Action 306.

Thus, the same task at different times may require different modules that have to be downloaded onto the user equipment 130 and enabled, according to the plan. It will therefore be understood that, as previously mentioned, the flowchart represented in FIG. 3 is only a non-limiting example of the sequence of Actions that may be performed by the first node 111.

Second example: In this second example, it will be illustrated how different modules may need to be downloaded for a same task. The task in this example is: (OpenDoor 4 SUCC_IntrusionDetection). This may be understood to mean that when OpenDoor predicate is true, indicating the door is opened, the modules in the firmwares in the devices comprised in the user equipment 130 may need to orchestrate to achieve the predicate SUCC_IntrusionDetection.

For this second example, it is assumed that the action Act_takeHighResImage has a dependence on the current quality of the camera sensor, which may give uncertain results. This may be specified through the predicate (sensor_OK):
(LI_OK and OpenDoor)
   Act_takeHighResImage
(sensor_OK)->(Is_GoodImage)
(sensor_NOK)->not(Is_GoodImage)

In this case, even if the light intensity is OK, the output of the high resolution camera may need to be enhanced in case the sensor has a temporary problem. Here, it may also be assumed that the Camera_Module_1 was already downloaded in the Camera device of the user equipment 130:

Act_measureLI
Act_takeHighResImage
Remove Camera_Module_1
Download Camera_Module_2
Enable Camera_Module_2
Act_EnhanceImage
Act_ProcessImage

In order to carry out this plan, the first node 111 may perform the following steps when executing the plan:

### Step 1:

LI Monitor: LI_module_1
Camera: Image_Module_1, Process_Module_1
Execute
Act_measureLI
Act_takeHighResImage

### Step 2:

Remove Image_Module_1, download Image_Module_2, Enable Image_Module_2,
Execute
Act_EnhanceImage
Act_ProcessImage

Here, for even a single task, different modules, Image_Module_1, and Image_Module_2, may need to be downloaded, and previous modules, Image_Module_1, may need to be removed.

As may be concluded from the above, even for a small use case such as the task “Whenever door is open, get an image of the room and process the image to check if there is a human in the image”, to orchestrate the different modules of firmware that may be required in the user equipment 130 in different situations is non-trivial. By the first node 111 iterating the invoking of Action 302, the downloading of Action 305, the enabling of Action 306 and the registering of Action 307 for every task comprised in the first plurality of tasks, the first node 111 may derive rules or controllers to perform an automatic, dynamic orchestration of the different modules of firmware that may be required. Therefore, the first node 111 may be understood to enable to compose the firmware for the user equipment 130 dynamically, depending upon the task or tasks to be executed, without being limited by any hardware constraints the user equipment 130 may have.

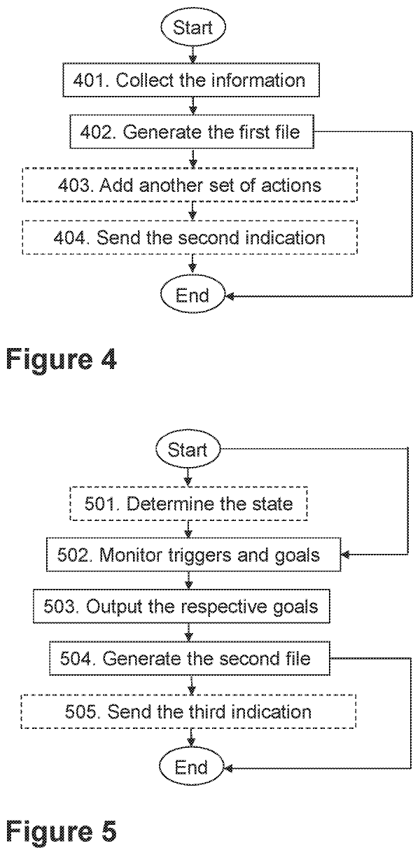

Embodiments of a method performed by the third node 113, will now be described with reference to the flowchart depicted in FIG. 4. The method is for handling firmware. The third node 113 operates in the communications network 10. In examples of embodiments herein, the third node 113 may be referred to as a domain builder.

The method may comprise the following actions. Several embodiments are comprised herein. In some embodiments, some actions may be performed, in other embodiments, all actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are represented in boxes with dashed lines.

The detailed description of some of the following corresponds to the same references provided above, in relation to the actions described for the first node 111, and will thus not be repeated here to simplify the description. For example, a task may be specified as a tuple <trigger, Goal>.

Action 401

In this Action 401, the third node 113 collects information. The information indicates, for a respective module of a plurality of modules of firmware, the following. First, the information indicates one or more actions, also referred to herein as capabilities. Each of the actions corresponds to a task of a plurality of tasks to be performed by user equipments, such as the user equipment 130. Each of the one or more actions comprises a respective set of preconditions and effects, as described earlier. Second, the information indicates management actions supported by a plurality of types of user equipments. And third, a respective type of user equipments supporting the respective module.

Collecting may be understood as e.g., gathering or obtaining, for example, from the second network node 112, via the second link 142. Collecting may be implemented through a file read, e.g., through a REST API.

The collecting in this Action 401 may be performed, for example, when a task trigger is true.

That each of the actions corresponds to a task a of plurality of tasks to be performed by user equipments may be understood to mean that the one or more actions may contribute to the achievement of the task of the plurality of tasks to be performed by user equipments. The plurality of types of user equipments may be understood to comprise a respective type of the user equipment 130.

Action 402

After collecting the information, in this Action 402, the third node 113 generates a first file based on the collected information. The first file has a Planning Domain Definition Language (PDDL) format.

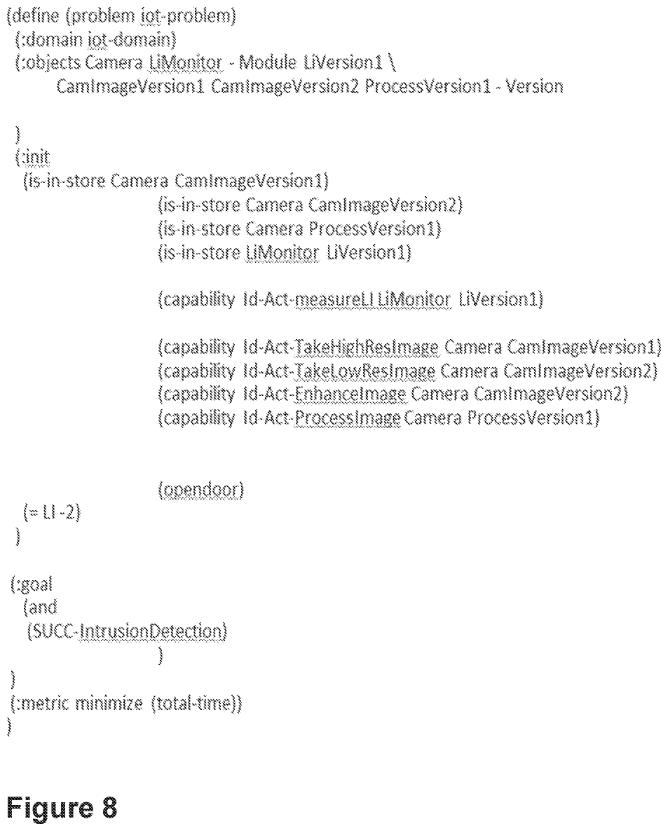

A non-limiting example of such a first file is shown in FIG. 8.

By generating the first file in this Action 402 having the PDDL format, the third node 113 may enable generation of a plan via off-the shelf planners which may parse and process the standard format in which the first file may be formatted.

Action 403

In this Action 403, the third node 113 may add, to the generated first file, another set of management actions. The another set of management actions may comprise one or more predicates indicating an availability of at least one of the one or more actions. The availability may be understood to be in the user equipment 130, or in the one of the devices that may be comprised in the user equipment 130.

By performing this Action 403, the third node 113 may enable the swapping of modules, as may be required by the memory constraints of the user equipment 130, or of the devices that may be comprised in the user equipment 130.

Action 404

The third node 113 may, in this Action 404, send a second indication to the fifth node 115 operating in the communications network 10. The second indication may be based on the generated first file. That is the second indication may comprise the generated first file.

The sending in this Action 404 may be implemented, e.g., via the third link 143.

By sending the second indication in this Action 404, the third node 113 enables the fifth node 115 to then determine a plan to achieve the goal for a respective task to be performed by the user equipment 130, according to the one or more actions and the management actions that may be supported the type of user equipment corresponding to the user equipment 130, so the fifth node 115 may know the library of actions and management actions it may choose from.

By the first file having the PDDL format, off-the shelf planners may be used, that may parse and process the standard format in which the first file may be formatted.

Embodiments of a method performed by a fourth node 114 comprised in the fourth node 114, will now be described with reference to the flowchart depicted in FIG. 5. The method is for handling firmware. The fourth node 114 operates in the communications network 10. In examples of embodiments herein, the fourth node 114 may be referred to as a problem builder.

The method comprises the following actions. Several embodiments are comprised herein. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111, and will thus not be repeated here to simplify the description. For example, a task may be specified as a tuple <trigger, Goal>.

Action 501

In this Action 501, the fourth node 114 may determine a state of the user equipment 130, which may be e.g., an IoT device. The state may comprise one or more of: a) which modules of firmware are installed and/or enabled in the user equipment 130, b) which actions to be performed by the user equipment 130 are enabled in the user equipment 130, each action corresponding to a respective module of a respective plurality of modules of firmware to perform the respective action, and c) which respective module of the respective plurality of modules of firmware to perform the respective action is installed and/or enabled in the user equipment 130. See FIG. 2.

Determining may be understood as e.g., calculating or deriving.

Each state of the user equipment 130 may be defined by a grounded set of predicates, that is, predicates where the variables have been replaced by concrete names of firmwares, modules and capabilities. The state that may be determined in this Action 501 may be understood as a current state. This determined state may then be provided to and used by the fifth node 115 to derive a plan, e.g., a sequence of actions.

Action 502

At any point of time, the requirement of a user or operator of the communications network 10 may be queued as the first plurality of tasks, e.g., (opendoor→succ_IntrusionDetection), (badDoorSensor->ImageEvery5Min). As described earlier, each task may be specified as a tuple <trigger, Goal>. When, for example, there may be no task execution pending, the fourth node 114 may monitor for the triggers associated with the first plurality of tasks. The triggers may be understood to be generated in the user equipment 130, e.g., by current sensor values, such as, e.g., doorOpen, sensor_OK etc. . . . , or come from external systems, and signal the set of tasks whose goals may need to be satisfied at present. In this Action 502, the fourth node 114 monitors whether or not at least one trigger of a plurality of triggers is met in the communications network 10. Each trigger in the plurality of triggers corresponds to a respective task of the first plurality of tasks to be performed by the user equipment 130 operating in the communications network 10.

The monitoring in this Action 502 may be implemented by, for example, periodically obtaining, requesting, or fetching the relevant information from the second node 1112 to evaluate whether a task trigger is true. The second node 112 may have stored the predicates that may be derived from external sources such as sensors, for an environment state, and LWM2M servers, for a device state. The fourth node 114 may additionally, or alternatively, register a call back with the second node 112, such that when the trigger is true, the second node 112 informs the fourth node 114. The messaging may be, albeit not limited to, through REST API or publish-subscribe mechanisms.

The plurality of triggers in this Action 502 may be understood as those specified in the queued set of tasks, that is, in the first plurality of tasks.

Action 503

When, based on the monitoring of Action 502, there may be matching triggers. In this Action 503, the fourth node 114 outputs a respective goal or goals of a plurality of goals, corresponding to the triggers that are met. That is, the fourth node 114 may in this Action 503 collect the goal predicates corresponding to the matched triggers. For example, for the trigger “doorOpen”, the output respective goal may be “SUCC_Intrusion Detection”.

Action 504

In this Action 504, the fourth node 114 generates a second file based on a result of the monitoring of Action 502 and the outputting of Action 503. The second file has a Planning Domain Definition Language format. The second file, or PDDL problem file, may indicate an initial state of the user equipment 130, as predicates denoted by the current sensor values, such as, e.g., doorOpen, sensor_OK etc., using e.g., the determined state in Action 501. The second file may also indicate a goal state of the user equipment 130, which may be understood as a union of the goal predicates for which the trigger is true.

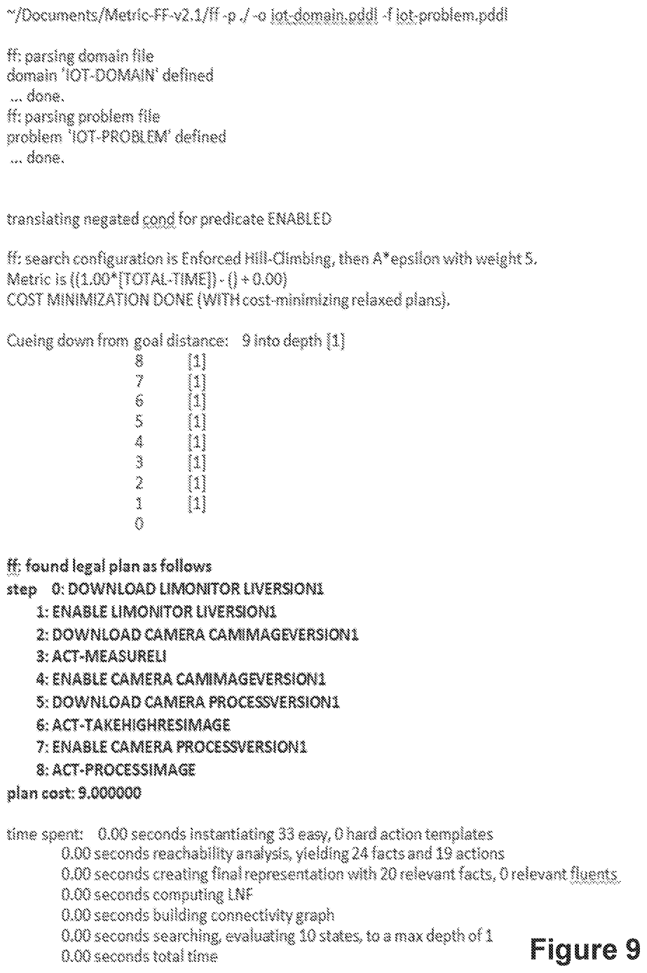

A non-limiting example of such a first file is shown in FIG. 9.

Action 505

In this Action 505, the fourth node 114 may send a third indication to the fifth node 115 operating in the communications network 10. The third indication may be based on at least one of: the generated second file and the determined state of the user equipment 130. The second file may be understood as a PDDL problem that in this Action 505 may be provided to the fifth node 115, which may be understood as an AI planner.

The sending in this Action 505 may be implemented, for example, via the fourth link 144.

By sending the third indication to the fifth node 115, the fourth node 114 enables the fifth node 115 to generate a plan.

By the second file having a PDDL format, off-the shelf planner tools may be used to implement the fifth node 115.

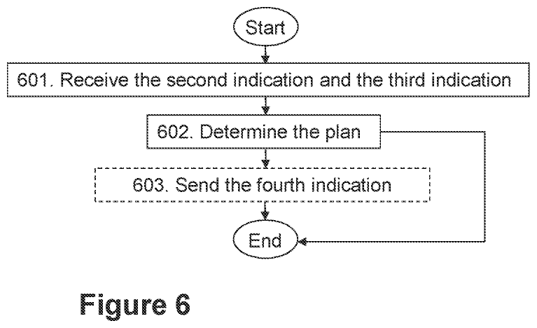

Embodiments of a method performed by any fifth node 115 comprised in the fifth node 115, will now be described with reference to the flowchart depicted in FIG. 6. The method is for handling firmware. The fifth node 115 operates in the communications network 10. In examples of embodiments herein, the fifth node 115 may be referred to as an AI planner.

The method comprises the following actions. Several embodiments are comprised herein. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111, and will thus not be repeated here to simplify the description. For example, a task may be specified as a tuple <trigger, Goal>.

Action 601

In this Action 601, the fifth node 115 receives the second indication from the third node 113 operating in the communications network 10, e.g., via the third link 143. The second indication comprises the information indicating, for the respective module of the plurality of modules of the firmware, the one or more actions. Each of the actions corresponds to a task of the plurality of tasks to be performed by user equipments. Each of the one or more actions comprises the respective set of preconditions and effects. The information comprised in the second indication also indicates, for the respective module of the plurality of modules of the firmware, the management actions supported by the plurality of types of user equipments, and the respective type of user equipment supporting the respective module. The user equipments may be understood to comprise the user equipment 130.

The receiving of the second indication in this Action 601 may be implemented, e.g., via the third link 143.

In this Action 601, the fifth node 115 also receives the third indication from the fourth node 114 operating in the communications network 10, e.g., via the fourth link 144. The third indication indicates the one or more goals of the plurality of goals to be accomplished when at least one trigger of the plurality of triggers is met in the communications network 10. Each trigger in the plurality of triggers corresponds to the respective task of the first plurality of tasks to be performed by the user equipment 130 operating in the communications network 10. The third indication also indicates the state of the user equipment 130.

The receiving of the third indication in this Action 601 may be implemented, e.g., via the fourth link 144.

It may be understood that the fifth node 115 may receive the second indication and the third indication in different points in time, and not necessarily simultaneously.

Action 602

In this Action 602, the fifth node 115, determines, based on the received second indication and the received third indication, a plan to achieve the goal for the respective task to be performed by the user equipment 130. The determining in this Action 602 is based on the respective type of the user equipment 130. The respective type of the user equipment 130 may have been derived by the fifth node 115, e.g., from the first file comprised in the second indication, as well as from e.g., an identifier of the user equipment 130 obtained by the fifth node 115.

In some embodiments, the determining in this Action 602 of the plan may be further based on an available memory of the user equipment 130 and a cost of downloading, onto the user equipment 130, the respective module of firmware corresponding to any of the actions corresponding to the respective task to be performed by the user equipment 130.

The plan may be determined in this Action 602 by a variety of AI planning techniques, such as forward and backward search, heuristic search, satisfiability etc.

In some of the embodiments, in an optimization procedure, the fifth node 115 may model the cost of a download in a “download” action depending upon a size of a module. This may be performed, for example, by deriving a metric such that the cost of the download of modules may be minimized. The fifth node 115 may also model the available memory of the user equipment 130. A module may be downloaded when the available memory permits it.

By minimizing the “download_cost”, the plan generated may try to minimize the number of downloads of modules and minimize a number of module switches. This may be understood to imply a) finding the smallest modules that may perform the task, and/or b) keep the earlier modules, but disable them, as part of the determined plan, as far as possible.

The fifth node 115 may be understood to, in this Action 602, be able to automatically generate the minimum cost plan based on the specification. No manual intervention may be necessary.

The optimization procedure performed by the fifth node 115 may, for example, be performed according the following four management actions: download, enable, disable and remove, each with its respective precondition(s) and effect(s). These show the way of specifying the semantics of management actions where memory constraints may be taken into account to decide disabling and removing modules to make space for modules to be downloaded:

1. Download (f: firmware, m: module)
Precondition: (is-in-store f m) AND (>available_memory size(f, m))
Effect: (is-in-device f m) AND not(enabled(c, f, m)))
   AND (assign available_memory (−available-memory size(f, m))
   AND (increase download_cost f(size(f, m)))

Available memory may be understood to decrease once a module is downloaded and increase when it is removed.

2. Enable (f: firmware, m: module m: module)
Precondition: (is-in-device f m), not (enabled (f, m))
Effect: enabled(c, f, m) AND (for-all (c) (capability (c, f, m)=>enabled-capability(c))) AND enabled (f, m)

3. Disable (f: firmware, m: module m: module)
Precondition: (is-in-device f m), enabled (f, m)
Effect: not(enabled(c, f, m)) AND (for-all (c) (capability (c, f, m)=>not(enabled-capability(c))))

4. Remove
Precondition: (is-in-device m), (disabled m)
Effect: (for-all (c) (capability c, f, m)=>not (enabled-capability (c))
   AND not (enabled (c, f, m) AND not (is-in-device m)
   AND (assign available_memory (+available-memory size(f, m))

Action 603

In this Action 603, the fifth node 115 may send a fourth indication to the second node 112 operating in the communications network 10. The fourth indication may indicate the determined plan. The sending in this Action 603 may be implemented via, e.g., the fifth link 145.

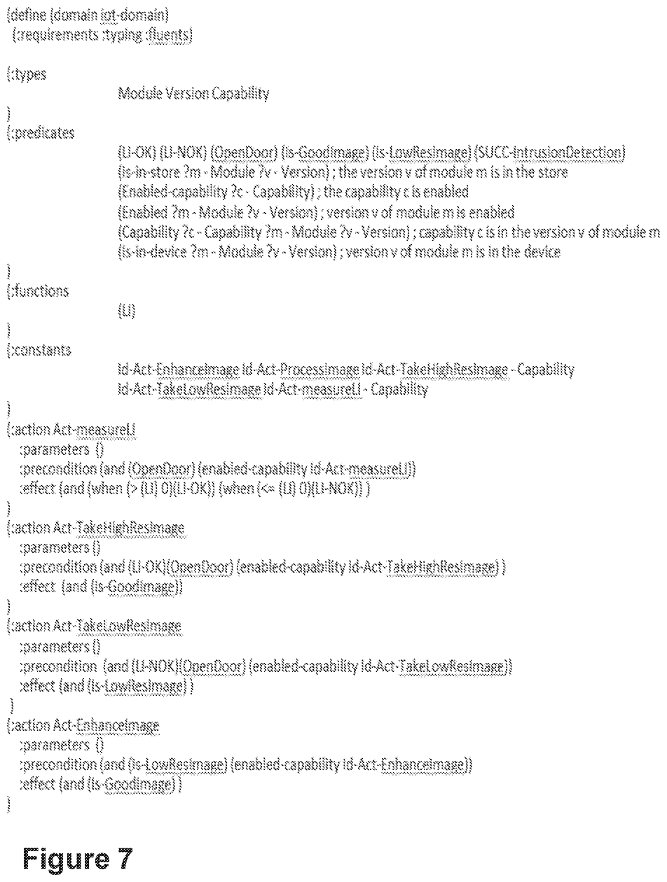

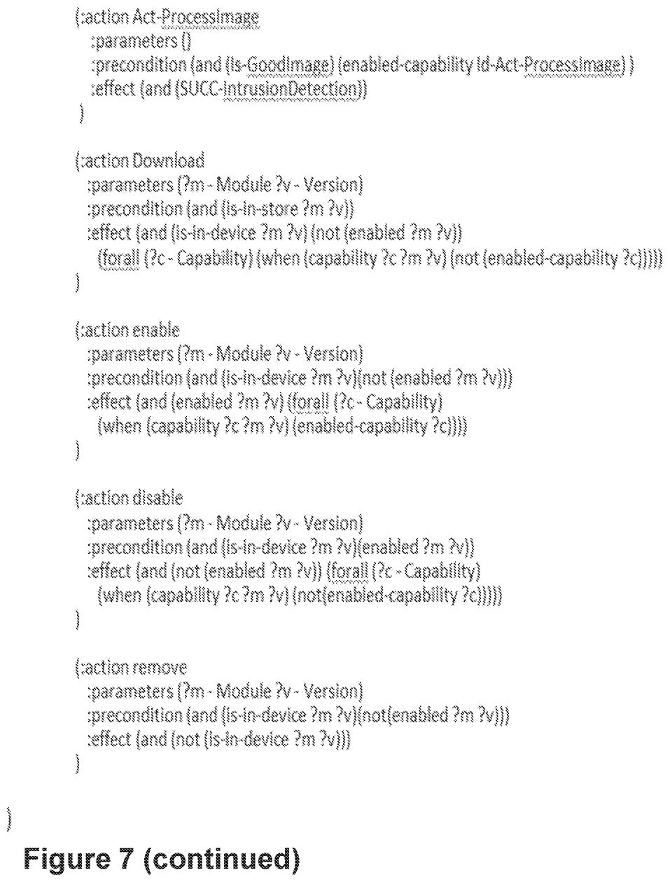

FIG. 7 depicts a non-limiting example of the first file, as a PDDL domain file, generated by the third node 113, for the running example, according to embodiments herein.

FIG. 8 depicts a non-limiting example of the second file, as a PDDL problem built by the fourth node 114 from a state where the modules are in the cloud store, and are to be downloaded onto the user equipment 130 for the intrusion task in the running example, according to embodiments herein.

FIG. 9 depicts a non-limiting example of a plan generated by the fifth node 115 from the domain and problem generated by the respective builders when there are no modules of firmware on the user equipment 130 and they are to be downloaded for intrusion detection when light intensity if good (LI>0), according to embodiments herein.

The methods described herein as being implemented by the first node 111, the second node 112, the third node 113, the fourth node 114, and the fifth node 115 will now be described in further detail with specific non-limiting examples in the three Figures.

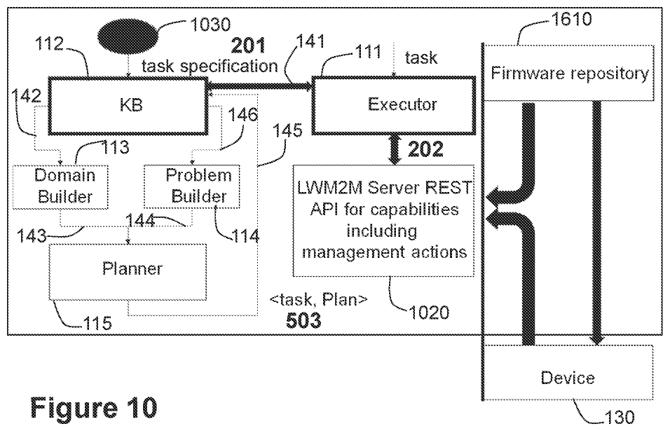

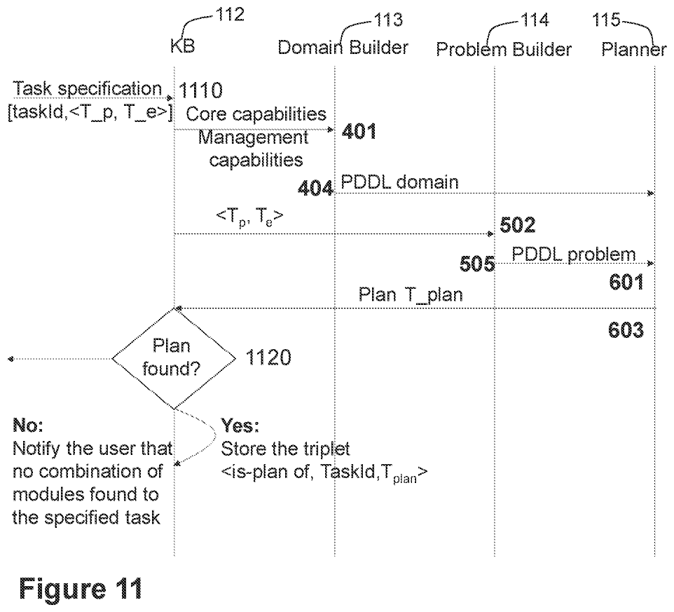

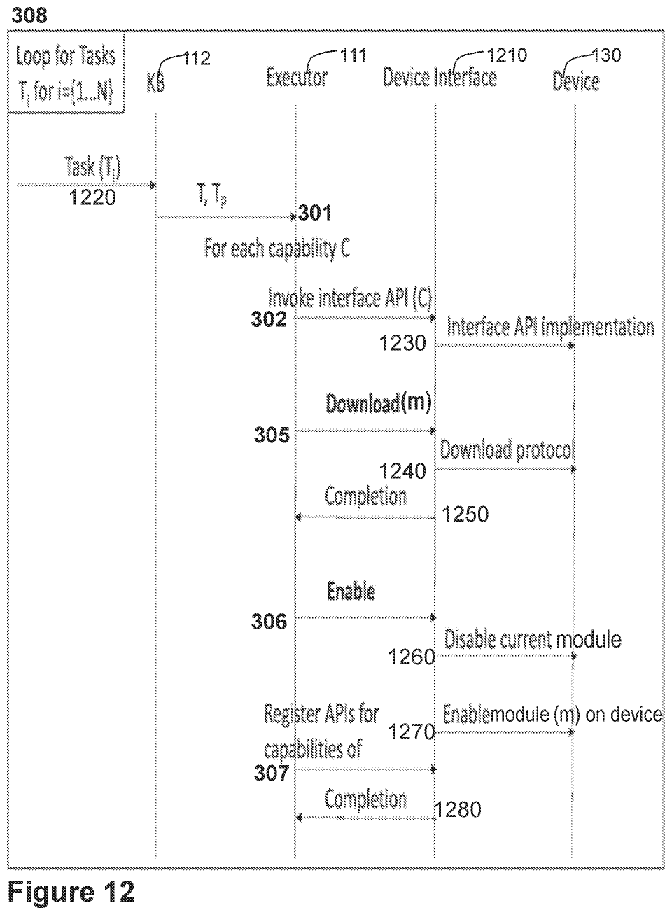

FIG. 10 is a schematic diagram depicting a non-limiting example of an architecture of the communications network 10, according to embodiments herein, which will be used to illustrate an example of the methods performed by the different nodes in FIG. 11 and FIG. 12. In this non-limiting example, the first node 111 is an executor, the second node 112 is a knowledgebase, the third node 113 is a domain builder, the fourth node 114 is a problem builder and the fifth node 115 is an AI planner. Also illustrated in FIG. 10 are the user equipment 130, depicted as “Device”, a firmware repository 610, an LWN2N server 620 comprising REST API for capabilities, including management actions, and a user 630 of the communications network 10. The user 630 provides its requirements to the second node 112 as the first plurality of tasks. The first node 111 receives the first indication comprising a task specification from the second node 112 via the first link 141, according to Action 301. The fifth node 115 sends the fourth indication indicating the determined plan to the second node 112, according to Action 603. The first node 111, according to Action 302, invokes the API corresponding to the actions in the task specification, based on the received first indication, from the LWM2M server 620.

The runtime behavior of the different nodes according to embodiments herein may be understood to have two distinct aspects: (1) a plan synthesis and storage, and (2) a task implementation as a plan execution. Each of these aspects is graphically represented, respectively, in FIG. 11 and FIG. 12.

FIG. 11 is a signalling diagram depicting a non-limiting example of a plan synthesis for tasks, according to embodiments herein. In this non-limiting example, the second node 112 is a knowledge base (KB), the third node 113 is a domain builder, the fourth node 114 is a problem builder and the fifth node 115 is an AI planner “Planner”. The signalling flow in this non-limiting example is the following, according to the numbering depicted in FIGS. 4, 5 and 6: At 1110, the user 630 provides its requirements to the second node 112 as the first plurality of tasks, that is, the task specification identified by a task identifier (taskId), and corresponding to the respective set of preconditions and effects, represented in FIG. 11 as <T_p, T_e>. The third node 113, in agreement with Action 401, collects the information indicating the one or more actions corresponding to the task, indicated in the Figure as “core capabilities”, as well as the management actions supported by the user equipment 130, indicated in the Figure as “management capabilities”. In accordance with Action 404, the third node 113 sends the second indication to the fifth node 115. The fourth node 114, in accordance with Action 502, monitors the triggers corresponds to the respective task. When at least a trigger is met, it sends the third indication to the fifth node 115, in accordance to Action 505, as a PDDL problem. The third indication is received by the fifth node 115 according to Action 601, and the fifth node 115 then generates and sends, according to Action 603, the fourth indication indicating the determined plan (T_plan), to the second node 112. At 1120, the second node 112 determines whether or not a plan has been found. If the answer is no, it may notify the user that no combination of modules was found to the specified task. If the plan is found, as is the case here, the second node 112 may store the found plan for the respective task as a triplet <is-plan of, TaskId,Tₚₗₐₙ>. The fifth node 115 sends the fourth indication indicating the determined plan to the second node 112, according to Action 603. The first node 111, according to Action 302, invokes the API corresponding to the actions in the task specification, based on the received first indication, from the LWM2M server 1020. The LWM2M server 1020 may access the firmware repository 1610 to download a module as specified by the management action, and may flash this into the user equipment 130, or the respective device comprised in the user equipment 130. In an embodiment, the firmware repository 1610 may be a service, and the LWM2M server 1020 may access the modules via REST API. The LWM2M server 1020 may interact with the user equipment 130, or the respective device comprised in the user equipment 130 to implement the capabilities, again as specified by the plan. The LWM2M server 1020 may be based on the LWM2M protocol that may allow the protocol to observe and control IoT devices. Whenever there may be a new module of firmware, resulting in different or new actions or capabilities, the second node 112, which is here a KB, may need to be updated. The next phase of task execution, after the current execution, if any, completes, may then take into account the new content of the second node 112, to build the domain file and thus, take advantage of the new capabilities. Given a task Tᵢ, the corresponding plan may then be accessed from the second node 112, and it may be executed sequentially, or in a topological order, if the plan may be a partial order. The advantage provided by storing the synthesized plan in the second node 112 may be understood to be that, at times when the same initial state may be the same, and the same task goals may need to be achieved, it may be possible to directly extract the plan from the second node 112, instead of invoking the third node 113.

FIG. 12 is a signalling diagram depicting a non-limiting example of plan execution according to embodiments herein. In this non-limiting example, the first node 111 is an executor, and the second node 112 is a knowledge base (KB). Also represented in the Figure is the user equipment 130, represented as “Device”, and the Device Interface 1210. The signalling flow in this non-limiting example is the following, according to the numbering depicted in FIG. 3: At 1220, the user 630 provides the first plurality of tasks Tᵢ to the second node 112. The first node 111 receives the first indication comprising the first plurality of tasks from the second node 112, according to Action 301. For each action, or capability, “C” in the task specification, the first node 111, according to Action 302, invokes the corresponding API “API (C)”. At 1230, the API (C) is implemented on the user equipment 130. The first node 111, according to Action 305, downloads the module of firmware corresponding to the action “V” onto the user equipment 130, via a download protocol of the device interface 1210, which is implemented at 1240. At 1250, the device interface 1210 notifies of the first node 111 that the download has been completed. The first node 111 then, according to Action 306, enables the downloaded module “m” onto the user equipment 130 via the device interface 1210. In this particular example, it is the device interface 1210 that first disables the current module of the firmware at 1260, and then at 1270 enables module “m” on the user equipment 130. The first node 111 then, according to Action 307, registers the APIs for the actions of module “m” with the device interface 1210. At 1280, the device interface 1210 notifies the first node 111 of the completion of the registration. A similar sequence is then, according to Action 308, iterated for every task in first plurality of tasks Tᵢ, from 1 to N.

Each action, core or capability, may be executed according to the following detail. Initially, only the interfaces for the management capabilities may be found in the interface 1210 of the user equipment 130:
1. Download: the interface may provide a download function implementation that may be governed by the standards, if any. At the completion, the firmware image may be in the user equipment 130.
2. Enable: When the firmware module is enabled, the core capabilities may be registered in the interface of the user equipment 130.
3. Disable: When the firmware module is disabled, the capabilities in the module are disabled, while the module may reside in the user equipment 130.
4. Remove: the firmware module may be totally erased from the memory of the user equipment 130.
5. Core capability: the registered API for the core capability may be invoked.

As a simplified example overview of the foregoing, embodiments herein may be understood to relate to methods to enable orchestration of different modules of IoT firmware modules to support all tasks developed throughout the life-cycle of an lot-based system. Embodiments herein may use a knowledge base for devices, firmware modules and their capabilities. This may be used to derive PDDL domains and problems. Special management actions and their semantics may be stored in the knowledge base, which enables the planning of the download/enable/remove of required modules of the firmware. Embodiments herein may use a protocol for execution of the tasks through the corresponding plans, which may comprise a systematic exposure of current capabilities through the interface such as LWM2M.

One advantage of embodiments herein is that they enable that all legacy tasks in resource-constrained IoT devices may be supported. This is enabled through an orchestration of different modules of firmware dynamically composing the firmwares in a device. This may be automatically performed through AI planning. If there are real-time constraints for the task, the recomposition of firmware with different modules may not satisfy such constraints. One of the aspects of embodiments herein is the design of a metric such that the cost of the download of modules may be minimized and the derivation of an optimal plan that minimizes module switches.

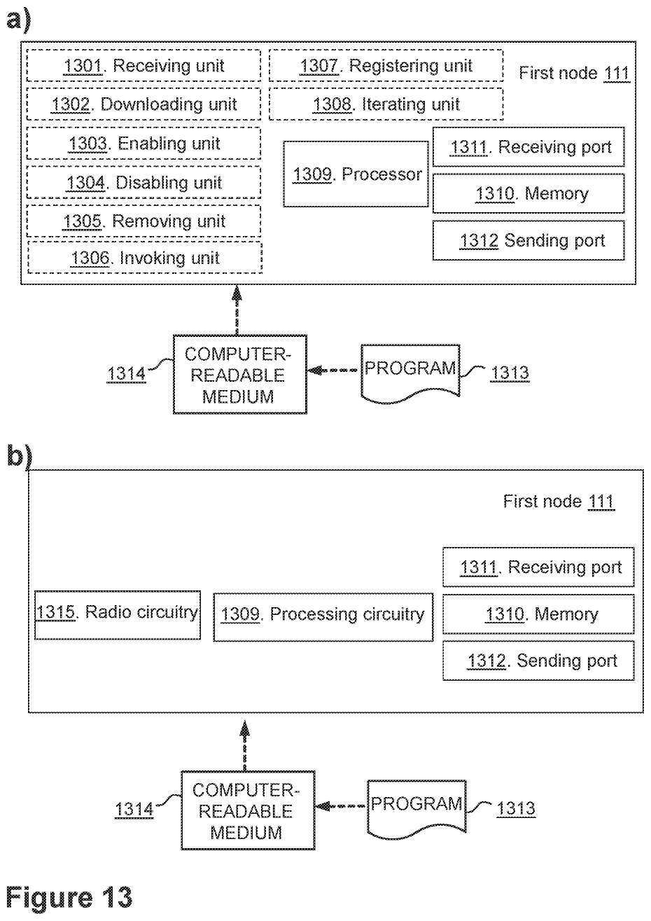

FIG. 13 depicts two different examples in panels a) and b), respectively, of the arrangement that the first node 111 may comprise to perform the method actions described above in relation to FIG. 3. In some embodiments, the first node 111 may comprise the following arrangement depicted in FIG. 13a. The first node 111 is for handling firmware. The first node 111 is configured to operate in the communications network 10.

Several embodiments are comprised herein. Components from one embodiment may be tacitly assumed to be present in another embodiment and it will be obvious to a person skilled in the art how those components may be used in the other exemplary embodiments. In FIG. 13, optional boxes are indicated by dashed lines. The detailed description of some of the following corresponds to the same references provided above, in relation to the actions described for the first node 111, and will thus not be repeated here. For example, a task may be configured to be specified as a tuple <trigger, Goal>.

The first node 111 is configured to, e.g. by means of a receiving unit 1301 within the first node 111 configured to, receive the first indication from the second node 112 configured to operate in the communications network 10. The first indication is configured to indicate the task to be performed by the user equipment 130 configured to operate in the communications network 10. The task is configured to indicate the action to be performed by the user equipment 130. The action is configured to correspond to the module of the plurality of modules of firmware to perform the action. The entire plurality of modules of firmware is not installed in the user equipment 130.

The first node 111 is also configured to, e.g. by means of a downloading unit 1302 within the first node 111 configured to, download the module of firmware corresponding to the action onto the user equipment 130, based on whether or not the module of firmware corresponding to the action onto the user equipment 130 is already downloaded in the user equipment 130.

The first node 111 is further configured to, e.g. by means of an enabling unit 1303 within the first node 111 configured to, enable, in the user equipment 130, the module of firmware corresponding to the action configured to be downloaded. To enable is further configured to be based on whether or not the module of firmware corresponding to the action configured to be downloaded is already enabled in the user equipment 130.

In some embodiments, the first node 111 may be further configured to, e.g. by means of a disabling unit 1304 within the first node 111 configured to, disable, in the user equipment 130, and based on the first indication configured to be received, any other module in the plurality of modules of firmware lacking support for the action.

In some embodiments, the first node 111 may be further configured to, e.g. by means of a removing unit 1305 within the first node 111 configured to, remove, from the user equipment 130, and based on the first indication configured to be received, at least one disabled module in the plurality of modules of firmware lacking support for the action. To remove may be configured to be based on an available storage capacity in the user equipment 130.

In some embodiments, the first node 111 may be further configured to, e.g. by means of an invoking unit 1306 within the first node 111 configured to, invoke on the user equipment 130 and based on the first indication configured to be received, an Application Program Interface (API) corresponding to the action. To invoke may be further configured to be based on whether or not the API corresponding to the action onto the user equipment 130 may be already registered.

In some embodiments, the first node 111 may be further configured to, e.g. by means of a registering unit 1307 within the first node 111 configured to, register, in the user equipment 130, the API corresponding to the action. To the register may be configured to be based on whether or not the API corresponding to the action onto the user equipment 130 is already registered.

In some embodiments, wherein the task may be configured to be comprised in the first plurality of tasks to be performed by the user equipment 130, as part of the plan configured to be indicated by the first indication, the first node 111 may be further configured to, e.g. by means of an iterating unit 1308 within the first node 111 configured to, iterate on the user equipment 130 and based on the first indication configured to be received, the API corresponding to the action. To invoke may be further configured to be based on whether or not the API corresponding to the action onto the user equipment 130 may be already registered.

The embodiments herein may be implemented through one or more processors, such as a processor 1309 in the first node 111 depicted in FIG. 13, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1310 comprising one or more memory units. The memory 1310 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, the fifth node 115, and/or the user equipment 130 through a receiving port 1311. In some examples, the receiving port 1311 may be, for example, connected to one or more antennas in the first node 111. In other embodiments, the first node 111 may receive information from another structure in the communications network 10 through the receiving port 1311. Since the receiving port 1311 may be in communication with the processor 1309, the receiving port 1311 may then send the received information to the processor 1309. The receiving port 1311 may also be configured to receive other information.

The processor 1309 in the first node 111 may be further configured to transmit or send information to e.g., the second node 112, the third node 113, the fourth node 114, the fifth node 115, and/or the user equipment 130, through a sending port 1312, which may be in communication with the processor 1309, and the memory 1310.

Those skilled in the art will also appreciate that any of the units 1301-1308 described above may refer to a combination of analog and digital circuits, and/or one or more processors configured with software and/or firmware, e.g., stored in memory, that, when executed by the one or more processors such as the processor 1309, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1301-1308 described above may be the processor 1309 of the first node 111, or an application running on such processor.

Thus, the methods according to the embodiments described herein for the first node 111 may be respectively implemented by means of a computer program 1313 product, comprising instructions, i.e., software code portions, which, when executed on at least one processor 1309, cause the at least one processor 1309 to carry out the actions described herein, as performed by the first node 111. The computer program 1313 product may be stored on a computer-readable storage medium 1314. The computer-readable storage medium 1314, having stored thereon the computer program 1313, may comprise instructions which, when executed on at least one processor 1309, cause the at least one processor 1309 to carry out the actions described herein, as performed by the first node 111. In some embodiments, the computer-readable storage medium 1314 may be a non-transitory computer-readable storage medium, such as a CD ROM disc, a memory stick, or stored in the cloud space. In other embodiments, the computer program 1313 product may be stored on a carrier containing the computer program, wherein the carrier is one of an electronic signal, optical signal, radio signal, or the computer-readable storage medium 1314, as described above.

The first node 111 may comprise an interface unit to facilitate communications between the first node 111 and other nodes or devices, e.g., the second node 112, the third node 113, the fourth node 114, the fifth node 115, and/or the user equipment 130. In some particular examples, the interface may, for example, include a transceiver configured to transmit and receive radio signals over an air interface in accordance with a suitable standard.

In other embodiments, the first node 111 may comprise the following arrangement depicted in FIG. 13b. The first node 111 may comprise a processing circuitry 1309, e.g., one or more processors such as the processor 1309, in the first node 111 and the memory 1310. The first node 111 may also comprise a radio circuitry 1315, which may comprise e.g., the receiving port 1311 and the sending port 1312. The processing circuitry 1309 may be configured to, or operable to, perform the method actions according to FIG. 3, in a similar manner as that described in relation to FIG. 13a. The radio circuitry 1315 may be configured to set up and maintain at least a wireless connection with the second node 112, the third node 113, the fourth node 114, the fifth node 115, the and/or the user equipment 130.

Hence, embodiments herein also relate to the first node 111 operative to handle firmware, the first node 111 being operative to operate in the communications network 10. The first node 111 may comprise the processing circuitry 1309 and the memory 1310, said memory 1310 containing instructions executable by said processing circuitry 1309, whereby the first node 111 is further operative to perform the actions described herein in relation to the first node 111, e.g., in FIG. 3.

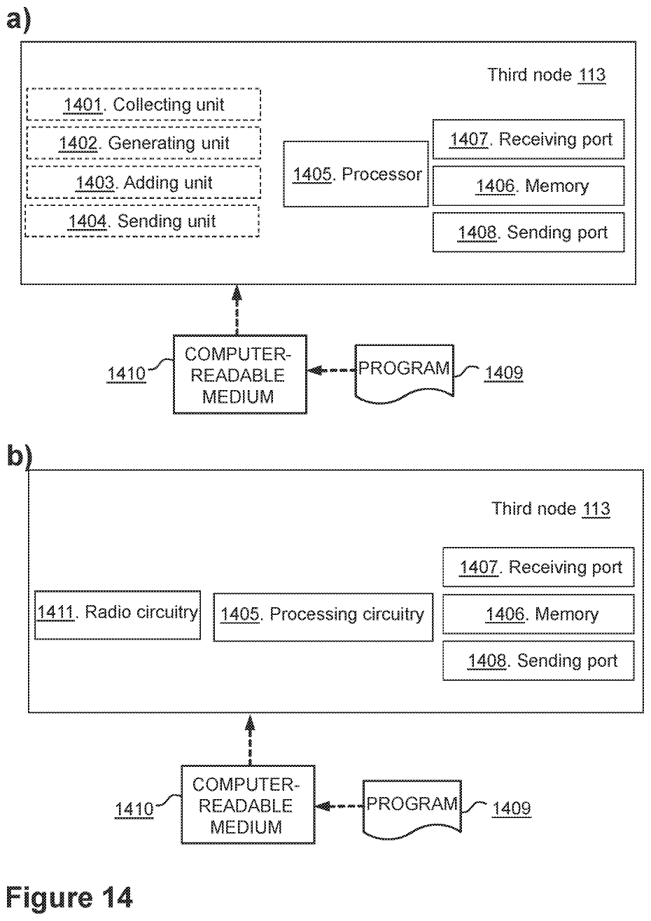

FIG. 14 depicts two different examples in panels a) and b), respectively, of the arrangement that the third node 113 may comprise to perform the method actions described above in relation to FIG. 4. In some embodiments, the third node 113 may comprise the following arrangement depicted in FIG. 14a. The third node 113 is configured to handle firmware. The third node 113 is configured to operate in the communications network 10.

Several embodiments are comprised herein. Components from one embodiment may be tacitly assumed to be present in another embodiment and it will be obvious to a person skilled in the art how those components may be used in the other exemplary embodiments. In FIG. 14, optional boxes are indicated by dashed lines. The detailed description of some of the following corresponds to the same references provided above, in relation to the actions described for the first node 111, and will thus not be repeated here. For example, a task may be configured to be specified as a tuple <trigger, Goal>.

The third node 113 is configured to, e.g. by means of a collecting unit 1401 within the third node 113 configured to, collect the information configured to indicate, for the respective module of the plurality of modules of firmware: a) the one or more actions, each of the actions corresponding to the task of plurality of tasks to be performed by user equipments, and each of the one or more actions being configured to comprise the respective set of preconditions and effects, b) the management actions configured to be supported by the plurality of types of user equipments, and c) the respective type of user equipments configured to support the respective module.

The third node 113 is also configured to, e.g. by means of a generating unit 1402 within the third node 113 configured to, generate the first file based on the information configured to be collected. The first file is configured to have the Planning Domain Definition Language format.

In some embodiments, the third node 113 may be configured to, e.g. by means of an adding unit 1403 within the third node 113 configured to, add, to the first file configured to be generated, another set of management actions. The another set of management actions may be configured to comprise one or more predicates configured to indicate the availability of at least one of the one or more actions.

In some embodiments, the third node 113 may be configured to, e.g. by means of a sending unit 1404 within the third node 113 configured to, send the second indication to the fifth node 115 configured to operate in the communications network 10. The second indication is configured to be based on the first file configured to be generated.

The embodiments herein may be implemented through one or more processors, such as a processor 1405 in the third node 113 depicted in FIG. 14, together with computer program code for performing the functions and actions of the embodiments herein. The program code mentioned above may also be provided as a computer program product, for instance in the form of a data carrier carrying computer program code for performing the embodiments herein when being loaded into the in the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 1406 comprising one or more memory units. The memory 1406 is arranged to be used to store obtained information, store data, configurations, schedulings, and applications etc. to perform the methods herein when being executed in the third node 113.

In some embodiments, the third node 113 may receive information from, e.g., the first node 111, the second node 112, the fourth node 114, the fifth node 115, and/or the user equipment 130, through a receiving port 1407. In some examples, the receiving port 1407 may be, for example, connected to one or more antennas in the third node 113. In other embodiments, the third node 113 may receive information from another structure in the communications network 10 through the receiving port 1407. Since the receiving port 1407 may be in communication with the processor 1405, the receiving port 1407 may then send the received information to the processor 1405. The receiving port 1407 may also be configured to receive other information.

The processor 1405 in the third node 113 may be further configured to transmit or send information to e.g., the first node 111, the second node 112, the fourth node 114, the fifth node 115, and/or the user equipment 130, through a sending port 1408, which may be in communication with the processor 1405, and the memory 1406.

Those skilled in the art will also appreciate that any of the units 1401-1404 described above may refer to a combination of analog and digital circuits, and/or one or more processors configured with software and/or firmware, e.g., stored in memory, that, when executed by the one or more processors such as the processor 1405, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1401-1404 described above may be the processor 1405 of the third node 113, or an application running on such processor.

Thus, the methods according to the embodiments described herein for the third node 113 may be respectively implemented by means of a computer program 1409 product, comprising instructions, i.e., software code portions, which, when executed on at least one processor 1405, cause the at least one processor 1405 to carry out the actions described herein, as performed by the third node 113. The computer program 1409 product may be stored on a computer-readable storage medium 1410. The computer-readable storage medium 1410, having stored thereon the computer program 1409, may comprise instructions which, when executed on at least one processor 1405, cause the at least one processor 1405 to carry out the actions described herein, as performed by the third node 113. In some embodiments, the computer-readable storage medium 1410 may be a non-transitory computer-readable storage medium, such as a CD ROM disc, a memory stick, or stored in the cloud space. In other embodiments, the computer program 1409 product may be stored on a carrier containing the computer program, wherein the carrier is one of an electronic signal, optical signal, radio signal, or the computer-readable storage medium 1410, as described above.

The third node 113 may comprise an interface unit to facilitate communications between the third node 113 and other nodes or devices, e.g., the first node 111, the second node 112, the fourth node 114, the fifth node 115, and/or the user equipment 130. In some particular examples, the interface may, for example, include a transceiver configured to transmit and receive radio signals over an air interface in accordance with a suitable standard.

In other embodiments, the third node 113 may comprise the following arrangement depicted in FIG. 14b. The third node 113 may comprise a processing circuitry 1405, e.g., one or more processors such as the processor 1405, in the third node 113 and the memory 1406. The third node 113 may also comprise a radio circuitry 1411, which may comprise e.g., the receiving port 1407 and the sending port 1408. The processing circuitry 1405 may be configured to, or operable to, perform the method actions according to FIG. 4, in a similar manner as that described in relation to FIG. 14a. The radio circuitry 1411 may be configured to set up and maintain at least a wireless connection with the first node 111, the second node 112, the fourth node 114, the fifth node 115, and/or the user equipment 130.

Hence, embodiments herein also relate to the third node 113 operative to handle firmware, the third node 113 being operative to operate in the communications network 10. The third node 113 may comprise the processing circuitry 1405 and the memory 1406, said memory 1406 containing instructions executable by said processing circuitry 1405, whereby the third node 113 is further operative to perform the actions described herein in relation to the third node 113, e.g., in FIG. 4.

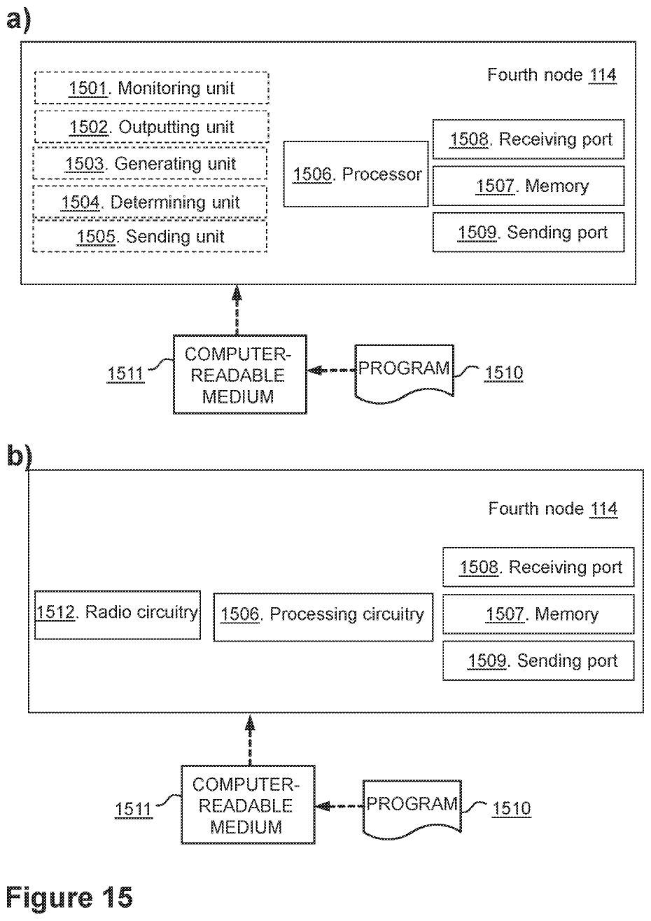

FIG. 15 depicts two different examples in panels a) and b), respectively, of the arrangement that the fourth node 114 may comprise to perform the method actions described above in relation to FIG. 5. In some embodiments, the fourth node 114 may comprise the following arrangement depicted in FIG. 15a. The fourth node 114 is configured to handle firmware. The fourth node 114 is configured to operate in the communications network 10.

Several embodiments are comprised herein. Components from one embodiment may be tacitly assumed to be present in another embodiment and it will be obvious to a person skilled in the art how those components may be used in the other exemplary embodiments. In FIG. 15, optional boxes are indicated by dashed lines. The detailed description of some of the following corresponds to the same references provided above, in relation to the actions described for the fourth node 114, and will thus not be repeated here. For example, a task may be configured to be specified as a tuple <trigger, Goal>.

The fourth node 114 is configured to, e.g. by means of a monitoring unit 1501 within the fourth node 114 configured to, monitor whether or not at least one trigger of the plurality of triggers is met in the communications network 10. Each trigger in the plurality of triggers corresponds to a respective task of the first plurality of tasks to be performed by the user equipment 130 configured to operate in the communications network 10.

The fourth node 114 is also configured to, e.g. by means of an outputting unit 1502 within the fourth node 114 configured to, output the respective goal or goals of the plurality of goals, corresponding to the triggers that are configured to be met.

The fourth node 114 is also configured to, e.g. by means of a generating unit 1503 within the fourth node 114 configured to, generate the second file based on the result of the monitoring and the outputting. The second file is configured to have the Planning Domain Definition Language format.

In some embodiments, the fourth node 114 may also be configured to, e.g. by means of a determining unit 1504 within the fourth node 114 configured to, determine the state of the user equipment 130. The state may be configured to comprise one or more of: a) which modules of firmware may be installed and/or enabled in the user equipment 130, b) which actions to be performed by the user equipment 130 may be enabled in the user equipment 130, each action corresponding to a respective module of a respective plurality of modules of firmware to perform the respective action, and c) which respective module of the respective plurality of modules of firmware to perform the respective action may be installed and/or enabled in the user equipment 130.

The fourth node 114 is also configured to, e.g. by means of a sending unit 1505 within the fourth node 114 configured to, send the third indication to the fifth node 115 configured to operate in the communications network 10. The third indication may be configured to be based on at least one of: the second file configured to be generated and the state of the user equipment 130 configured to be determined.

The embodiments herein may be implemented through one or more processors, such as a processor 1506 in the fourth node 114 depicted in FIG. 15, together with computer program code for performing the functions and actions of the embodiments herein. The program code mentioned above may also be provided as a computer program product, for instance in the form of a data carrier carrying computer program code for performing the embodiments herein when being loaded into the in the fourth node 114. One such carrier may be in the form of a CD ROM disc. It is however feasible with other data carriers such as a memory stick. The computer program code may furthermore be provided as pure program code on a server and downloaded to the fourth node 114.

The fourth node 114 may further comprise a memory 1507 comprising one or more memory units. The memory 1507 is arranged to be used to store obtained information, store data, configurations, schedulings, and applications etc. to perform the methods herein when being executed in the fourth node 114.

In some embodiments, the fourth node 114 may receive information from, e.g., the first node 111, the second node 112, the third node 113, the fifth node 115, and/or the user equipment 130, through a receiving port 1508. In some examples, the receiving port 1508 may be, for example, connected to one or more antennas in the fourth node 114. In other embodiments, the fourth node 114 may receive information from another structure in the communications network 10 through the receiving port 1508. Since the receiving port 1508 may be in communication with the processor 1506, the receiving port 1508 may then send the received information to the processor 1506. The receiving port 1508 may also be configured to receive other information.

The processor 1506 in the fourth node 114 may be further configured to transmit or send information to e.g., the first node 111, the second node 112, the third node 113, the fifth node 115, and/or the user equipment 130, through a sending port 1509, which may be in communication with the processor 1506, and the memory 1507.

Those skilled in the art will also appreciate that the any of the units 1501-1505 described above may refer to a combination of analog and digital circuits, and/or one or more processors configured with software and/or firmware, e.g., stored in memory, that, when executed by the one or more processors such as the processor 1506, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the d units 1501-1505 described above may be the processor 1506 of the fourth node 114, or an application running on such processor.

Thus, the methods according to the embodiments described herein for the fourth node 114 may be respectively implemented by means of a computer program 1510 product, comprising instructions, i.e., software code portions, which, when executed on at least one processor 1506, cause the at least one processor 1506 to carry out the actions described herein, as performed by the fourth node 114. The computer program 1510 product may be stored on a computer-readable storage medium 1511. The computer-readable storage medium 1511, having stored thereon the computer program 1510, may comprise instructions which, when executed on at least one processor 1506, cause the at least one processor 1506 to carry out the actions described herein, as performed by the fourth node 114. In some embodiments, the computer-readable storage medium 1511 may be a non-transitory computer-readable storage medium, such as a CD ROM disc, a memory stick, or stored in the cloud space. In other embodiments, the computer program 1510 product may be stored on a carrier containing the computer program, wherein the carrier is one of an electronic signal, optical signal, radio signal, or the computer-readable storage medium 1511, as described above.

The fourth node 114 may comprise an interface unit to facilitate communications between the fourth node 114 and other nodes or devices, e.g., the first node 111, the second node 112, the third node 113, the fifth node 115, and/or the user equipment 130. In some particular examples, the interface may, for example, include a transceiver configured to transmit and receive radio signals over an air interface in accordance with a suitable standard.

In other embodiments, the fourth node 114 may comprise the following arrangement depicted in FIG. 15b. The fourth node 114 may comprise a processing circuitry 1506, e.g., one or more processors such as the processor 1506, in the fourth node 114 and the memory 1507. The fourth node 114 may also comprise a radio circuitry 1512, which may comprise e.g., the receiving port 1508 and the sending port 1509. The processing circuitry 1506 may be configured to, or operable to, perform the method actions according to FIG. 5, in a similar manner as that described in relation to FIG. 15a. The radio circuitry 1512 may be configured to set up and maintain at least a wireless connection with the first node 111, the second node 112, the third node 113, the fifth node 115, and/or the user equipment 130.

Hence, embodiments herein also relate to the fourth node 114 operative to handle firmware, the fourth node 114 being operative to operate in the communications network 10. The fourth node 114 may comprise the processing circuitry 1506 and the memory 1507, said memory 1507 containing instructions executable by said processing circuitry 1506, whereby the fourth node 114 is further operative to perform the actions described herein in relation to the fourth node 114, e.g., in FIG. 5.

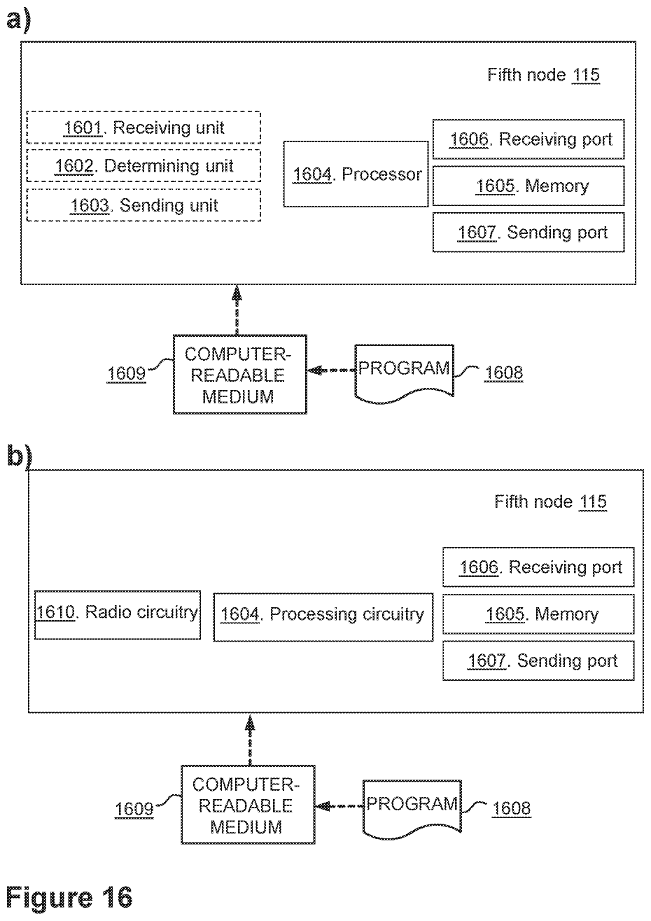

FIG. 16 depicts two different examples in panels a) and b), respectively, of the arrangement that the fifth node 115 may comprise to perform the method actions described above in relation to FIG. 6. In some embodiments, the fifth node 115 may comprise the following arrangement depicted in FIG. 16a. The fifth node 115 is configured to handle firmware. The fifth node 115 is configured to operate in the communications network 10.

Several embodiments are comprised herein. Components from one embodiment may be tacitly assumed to be present in another embodiment and it will be obvious to a person skilled in the art how those components may be used in the other exemplary embodiments. In FIG. 16, optional boxes are indicated by dashed lines. The detailed description of some of the following corresponds to the same references provided above, in relation to the actions described for the fifth node 115, and will thus not be repeated here. For example, a task may be configured to be specified as a tuple <trigger, Goal>.

The fifth node 115 is configured to, e.g. by means of a receiving unit 1601 within the fifth node 115 configured to, receive: a) the second indication from the third node 113 configured to operate in the communications network 10; the second indication is configured to comprise the information configured to indicate, for a respective module of the plurality of modules of firmware: i) the one or more actions, each of the actions corresponding to a task of the plurality of tasks to be performed by user equipments, and each of the one or more actions comprising a respective set of preconditions and effects, ii) the management actions supported by the plurality of types of user equipments, and iii) the respective type of user equipment supporting the respective module, and b) the third indication from the fourth node 114 configured to operate in the communications network 10. The third indication is configured to indicate: i) the one or more goals of the plurality of goals to be accomplished when at least one trigger of the plurality of triggers is met in the communications network 10; each trigger in the plurality of triggers corresponds to a respective task of the first plurality of tasks to be performed by a user equipment 130 configured to operate in the communications network 10, and ii) the state of the user equipment 130.

The fifth node 115 is also configured to, e.g. by means of a determining unit 1602 within the fifth node 115 configured to, determine, based on the second indication configured to be received and the third indication configured to be received, the plan to achieve the goal for the respective task to be performed by the user equipment 130. The determining is configured to be based on the respective type of the user equipment 130.

In some embodiments, to determine the plan is further configured to be based on the available memory of the user equipment 130 and the cost of downloading, onto the user equipment 130, the respective module of firmware corresponding to any of the actions corresponding to the respective task to be performed by the user equipment 130.

The fifth node 115 is also configured to, e.g. by means of a sending unit 1603 within the fifth node 115 configured to, send, the fourth indication to the second node 112 configured to operate in the communications network 10. The fourth indication is configured to indicate the plan configured to be determined.

The embodiments herein may be implemented through one or more processors, such as a processor 1604 in the fifth node 115 depicted in FIG. 16, together with computer program code for performing the functions and actions of the embodiments herein. The program code mentioned above may also be provided as a computer program product, for instance in the form of a data carrier carrying computer program code for performing the embodiments herein when being loaded into the in the fifth node 115. One such carrier may be in the form of a CD ROM disc. It is however feasible with other data carriers such as a memory stick. The computer program code may furthermore be provided as pure program code on a server and downloaded to the fifth node 115.

The fifth node 115 may further comprise a memory 1605 comprising one or more memory units. The memory 1605 is arranged to be used to store obtained information, store data, configurations, schedulings, and applications etc. to perform the methods herein when being executed in the fifth node 115.

In some embodiments, the fifth node 115 may receive information from, e.g., the first node 111, the second node 112, the third node 113, the fourth node 114, and/or the set of user equipments 130, through a receiving port 1606. In some examples, the receiving port 1606 may be, for example, connected to one or more antennas in the fifth node 115. In other embodiments, the fifth node 115 may receive information from another structure in the communications network 10 through the receiving port 1606. Since the receiving port 1606 may be in communication with the processor 1604, the receiving port 1606 may then send the received information to the processor 1604. The receiving port 1606 may also be configured to receive other information.

The processor 1604 in the fifth node 115 may be further configured to transmit or send information to e.g., the first node 111, the second node 112, the third node 113, the fourth node 114, and/or the set of user equipments 130, through a sending port 1607, which may be in communication with the processor 1604, and the memory 1605.

Those skilled in the art will also appreciate that the any of the units 1601-1603 described above may refer to a combination of analog and digital circuits, and/or one or more processors configured with software and/or firmware, e.g., stored in memory, that, when executed by the one or more processors such as the processor 1604, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the d units 1601-1603 described above may be the processor 1604 of the fifth node 115, or an application running on such processor.

Thus, the methods according to the embodiments described herein for the fifth node 115 may be respectively implemented by means of a computer program 1608 product, comprising instructions, i.e., software code portions, which, when executed on at least one processor 1604, cause the at least one processor 1604 to carry out the actions described herein, as performed by the fifth node 115. The computer program 1608 product may be stored on a computer-readable storage medium 1609. The computer-readable storage medium 1609, having stored thereon the computer program 1608, may comprise instructions which, when executed on at least one processor 1604, cause the at least one processor 1604 to carry out the actions described herein, as performed by the fifth node 115. In some embodiments, the computer-readable storage medium 1609 may be a non-transitory computer-readable storage medium, such as a CD ROM disc, a memory stick, or stored in the cloud space. In other embodiments, the computer program 1608 product may be stored on a carrier containing the computer program, wherein the carrier is one of an electronic signal, optical signal, radio signal, or the computer-readable storage medium 1609, as described above.

The fifth node 115 may comprise an interface unit to facilitate communications between the fifth node 115 and other nodes or devices, e.g., the first node 111, the second node 112, the third node 113, the fourth node 114, and/or the set of user equipments 130. In some particular examples, the interface may, for example, include a transceiver configured to transmit and receive radio signals over an air interface in accordance with a suitable standard.

In other embodiments, the fifth node 115 may comprise the following arrangement depicted in FIG. 16b. The fifth node 115 may comprise a processing circuitry 1604, e.g., one or more processors such as the processor 1604, in the fifth node 115 and the memory 1605. The fifth node 115 may also comprise a radio circuitry 1610, which may comprise e.g., the receiving port 1606 and the sending port 1607. The processing circuitry 1604 may be configured to, or operable to, perform the method actions according to FIG. 6, in a similar manner as that described in relation to FIG. 16a. The radio circuitry 1610 may be configured to set up and maintain at least a wireless connection with the first node 111, the second node 112, the third node 113, the fourth node 114, and/or the set of user equipments 130.

Hence, embodiments herein also relate to the fifth node 115 operative to handle firmware, the fifth node 115 being operative to operate in the communications network 10. The fifth node 115 may comprise the processing circuitry 1604 and the memory 1605, said memory 1605 containing instructions executable by said processing circuitry 1604, whereby the fifth node 115 is further operative to perform the actions described herein in relation to the fifth node 115, e.g., in FIG. 6.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1. A method, performed by a first node, for handling firmware, the first node operating in a communications network, the method comprising:
receiving a first indication from a second node operating in the communications network, the first indication indicating a task to be performed by a user equipment operating in the communications network, the task indicating an action to be performed by the user equipment, the action corresponding to a module of a plurality of modules of firmware to perform the action, wherein the entire plurality of modules of firmware is not installed in the user equipment,
downloading the module of firmware corresponding to the action onto the user equipment, based on whether or not the module of firmware corresponding to the action onto the user equipment is already downloaded in the user equipment, and
enabling, in the user equipment, the downloaded module of firmware corresponding to the action, the enabling being further based on whether or not the downloaded module of firmware corresponding to the action is already enabled in the user equipment.

2. The method according to claim 1, further comprising:
disabling, in the user equipment, and based on the received first indication, any other module in the plurality of modules of firmware lacking support for the action.

3. The method according to claim 2, further comprising:
removing, from the user equipment, and based on the received first indication, at least one disabled module in the plurality of modules of firmware lacking support for the action, the removing being based on an available storage capacity in the user equipment.

4. The method according to claim 1, further comprising:
invoking, on the user equipment and based on the received first indication, an Application Program Interface, API, corresponding to the action, the invoking being further based on whether or not the API corresponding to the action onto the user equipment is already registered.

5. The method according to claim 1, further comprising:
registering, in the user equipment, an API corresponding to the action, the registering being based on whether or not the API corresponding to the action onto the user equipment is already registered.

6. The method according to claim 1, wherein the task is comprised in a first plurality of tasks to be performed by the user equipment, as part of a plan indicated by the first indication, and wherein the method further comprises:
iterating one or more of: the invoking, the downloading, the enabling and the registering, for every task comprised in the first plurality of tasks.

7. A method, performed by a third node, for handling firmware, the third node operating in a communications network, the method comprising:
collecting information indicating, for a respective module of a plurality of modules of firmware:
a) one or more actions, each of the actions corresponding to a task a of plurality of tasks to be performed by user equipments, and each of the one or more actions comprising a respective set of preconditions and effects,
b) management actions supported by a plurality of types of user equipments, and
c) a respective type of user equipments supporting the respective module, and
generating a first file based on the collected information, the first file having a Planning Domain Definition Language format.

8. The method according to claim 7, wherein method further comprises:
adding, to the generated first file, another set of management actions, the another set of management actions comprising one or more predicates indicating an availability of at least one of the one or more actions.

9. The method according to claim 7, wherein method further comprises:
sending a second indication to a fifth node operating in the communications network, the second indication being based on the generated first file.

10. A method, performed by a fourth node, for handling firmware, the fourth node operating in a communications network, the method comprising:
monitoring whether or not at least one trigger of a plurality of triggers is met in the communications network, wherein each trigger in the plurality of triggers corresponds to a respective task of a first plurality of tasks to be performed by a user equipment operating in the communications network,
outputting a respective goal or goals of a plurality of goals, corresponding to the triggers that are met, and
generating a second file based on a result of the monitoring and the outputting, the second file having a Planning Domain Definition Language format.

11. The method according to claim 10, wherein method further comprises:
determining a state of the user equipment, the state comprising one or more of:
a) which modules of firmware are installed and/or enabled in the user equipment,
b) which actions to be performed by the user equipment are enabled in the user equipment, each action corresponding to a respective module of a respective plurality of modules of firmware to perform the respective action, and
c) which respective module of the respective plurality of modules of firmware to perform the respective action is installed and/or enabled in the user equipment.

12. The method according to claim 10, wherein method further comprises:
sending a third indication to the a fifth node operating in the communications network, the third indication being based on at least one of: the generated second file and the determined state of the user equipment.

13. A method, performed by a fifth node, for handling firmware, the first node operating in a communications network, the method comprising:
receiving:
a) a second indication from a third node operating in the communications network, the second indication comprising information indicating, for a respective module of a plurality of modules of firmware:
i. one or more actions, each of the actions corresponding to a task of a plurality of tasks to be performed by user equipments, and each of the one or more actions comprising a respective set of preconditions and effects,
ii. management actions supported by a plurality of types of user equipments, and
iii. a respective type of user equipment supporting the respective module, and
b) a third indication from a fourth node operating in the communications network, the third indication indicating:
i. one or more goals of a plurality of goals to be accomplished when at least one trigger of a plurality of triggers is met in the communications network, wherein each trigger in the plurality of triggers corresponds to a respective task of a first plurality of tasks to be performed by a user equipment operating in the communications network, and
ii. a state of the user equipment, and
determining, based on the received second indication and the received third indication, a plan to achieve the goal for the respective task to be performed by the user equipment, the determining being based on the respective type of the user equipment.

14. The method according to claim 13, wherein the determining of the plan is further based on an available memory of the user equipment and a cost of downloading, onto the user equipment, the respective module of firmware corresponding to any of the actions corresponding to the respective task to be performed by the user equipment.

15. The method according to claim 13, further comprising:
sending a fourth indication to the second node operating in the communications network, the fourth indication indicating the determined plan.

16.-30. (canceled)
